(19) United States
(12) Patent Application Publication
(10) Pub. No.: US 2025/0363455 A1
(43) Pub. Date: Nov. 27, 2025

(54) SYSTEMS AND METHODS FOR AUTOMATIC CHANGE EVIDENCE PROCESSING AND CHANGE IMPLEMENTATION

(71) Applicant: Wells Fargo Bank, N.A., San Francisco, CA (US)

(72) Inventors: David Edward Herwig, Paradise Valley, AZ (US); Alec McKinley, Minneapolis, MN (US)

(21) Appl. No.: 18/670,456

(22) Filed: May 21, 2024

(51) Int. Cl. G06Q 10/10; G06F 16/23

(52) U.S. Cl. CPC G06Q 10/103; G06F 16/2358

(57) ABSTRACT

Systems, apparatuses, methods, and computer program products are disclosed for automatic change evidence processing and change implementation using a three-level data taxonomy. An example method includes receiving a change request comprising a project identifier and a change request type. The example method further includes generating a support container, wherein the support container references the project identifier, and the support container is associated with a support container identifier. The example method further includes generating one or more evidentiary requirements that reference the support container identifier and are each associated with an evidentiary domain. The example method further includes receiving an evidentiary data record associated with the change request and identifying an evidentiary requirement associated with the evidentiary data record. The example method further includes updating the identified evidentiary requirement to reference the evidentiary data record.

### BACKGROUND

Change in a context of large projects or organizations may be subject to one or more management processes, procedures, protocols, and/or regulations. Organizations often implement these processes, procedures, protocols, and/or regulations to avoid negative consequences of unmanaged or poorly managed change. For example, a software update that has not been thoroughly tested and approved might lead to a critical computing system failure if implemented. Change management systems and methods typically seek to mitigate scenarios such as this by formalizing change implementation processes, procedures, protocols, and/or regulations.

### BRIEF SUMMARY

Certain activities within an organization require documentation for purposes of security, compliance, and to serve as an audit trail. For example, new products, product updates, new technology, etc. all have accompanying risks that must be addressed prior to deployment within an organization. Individual organizations often have established their own form of change management processes, procedures, protocols, and/or regulations to ensure proper implementation of such changes. These change management processes often require parties to submit documentation showing that requirements have been met to implement a given change to a system or method. This documentation may be in standardized formats (e.g. a form document which is filled out and submitted to certify completion of a task) or may be unstandardized (e.g. inspection reports from a variety of contractors in a variety of formats). In either case, determinations as to whether a particular piece of documentation fulfils a requirement are typically made by manually reviewing that piece of documentation.

It will be readily apparent that manually reviewing documentation related to a proposed change is a time- and labor-intensive task which introduces many opportunities for errors to occur. Current manual methods of reviewing documentation can add significantly to a time and cost of implementing a change, and in some cases can shift a cost-benefit analysis away from attempting a change which might save fewer resources than are expended in the change implementation process. Furthermore, current methods of managing change typically suffer from communication issues since information may be spread among many differing individuals, devices, and platforms, and may not be fully synchronized across the same. Thus, the scattering of relevant evidentiary documentation on disparate systems, computers, and applications creates a lack of transparency, inefficiencies, and inherent risk. It is therefore desirable to create a system which can automatically process documentation to quickly and efficiently approve and implement changes while providing up-to date progress data to involved stakeholders.

In contrast to these conventional techniques for handling change-related documentation, example embodiments described herein provide a new data taxonomy that allows for the alignment of development activities and evidentiary responsibilities and furthermore, is capable of measuring change progress and deliver traceable evidentiary data records. In particular, embodiments of the present invention define a three-level data taxonomy where a first (highest) level is associated with a particular project. Next, a second level is associated with a support container and in some embodiments, one or more divisible non-non-development tasks for the project. This mid-tier support container may be configured to aggregate and organize all evidentiary data records, such that this evidence is easily accessible to pertinent parties. Finally, a third level defines one or more evidentiary requirement which each are associated with a particular evidentiary domain and optionally, one or more non-development task requirements. In doing so, the data taxonomy described herein provides for transparent and efficient aggregation of evidentiary data records, thereby allowing for evidentiary data record association with the higher-level project for a change request as well as lower-level evidentiary requirements. Thus, the data taxonomy contemplated herein provides for a more efficiently structured change management architecture that is more computationally and space efficient by eliminating the need for users to search for evidentiary data records post hoc. Furthermore, this three-level data taxonomy may be implemented within an agile project management workflow and may allow for iterative change implementation for any given project in a flexible manner.

In some embodiments, the hierarchical relationship between different components may be maintained through the use of unique component references. In particular, a first level project may be assigned a project identifier that uniquely identifies the project. The second level support container and/or non-development tasks may reference this project identifier, such that the relationship between the second level components (e.g., the support container and non-development tasks) is structured and maintained. The support container may be assigned a unique support container identifier, which may uniquely identify the support container. The third level evidentiary requirements may reference this support container identifier and thereby maintain the hierarchical relationships between levels. Similarly, each second level non-development task may be assigned a non-development task identifier, which may uniquely identify the non-development task. One or more third level non-development task requirements may reference a particular non-development task identifier and similarly maintain a hierarchical relationship between levels.

In some embodiments a particular project (e.g., software, product, technology) may be associated with multiple changes (e.g., multiple versions, releases, or updates) and may therefore be associated with multiple change requests. Once a project identifier exists for a given project, additional change requests may result in an additional second level support container and additional third level evidentiary requirements. Here, the additional support container may reference the project identifier, thereby maintaining the relationship of changes made to a given project over time and provides for a centralized architecture with a traceable history of multiple change activities for a given project. In some embodiments, a change request is associated with a change identifier that may uniquely identify the change request. Each support container may further reference a corresponding change identifier such that multiple support containers may be associated with a given project and the change identifier may serve as a means to identify relevant second level and third level components associated with a particular change request. Thus, this data taxonomy maintains the relationship of changes made to a given project over time, thereby providing for a centralized architecture with a traceable history of multiple change activities for a given project.

In some embodiments, evidentiary data records may be received from client devices. An evidentiary data record may serve as evidence of compliance with established internal policies and procedures, governmental and/or institutional regulations, and/or or other organizational readiness activities. These received evidentiary data records may pertain to an evidentiary requirement of a given evidentiary domain. The relevant evidentiary requirement may be updated to reference or link to the received evidentiary data record such that these evidentiary data records, which serve as evidence of compliance for a given change request, are traceable and accessible.

In some embodiments, received evidentiary data records may be stored in a designated storage repository. The designated storage repository may be a secure, central storage location to store evidentiary data records. In some embodiments, the designated storage repository may be used as the primary storage location or may serve as a back-up storage location as a failsafe for issues with the primary storage location, such as if the original storage location and/or stored evidentiary data record becomes inaccessible. In this way, the storage location of evidentiary data records is known, and evidentiary requirements may reference or link to these locations such that these crucial evidentiary data records remain available and accessible. This provides for a more secure change management system by aggregating all relevant and necessary data in one place, thus eliminating the potential of losing or misplacing crucial evidentiary data records.

In some embodiments, a received evidentiary data record may be evaluated prior to being linked and/or referenced by an evidentiary data requirement to determine whether or not the evidentiary data record is compliant with various requirements for a given evidentiary requirement of an evidentiary domain. In some embodiments, the evidentiary requirement may be associated with one or more requisites that describe rules and/or conditions under which the evidentiary requirement may be completed. In some embodiments, the one or more requisites for the evidentiary requirement may define one or more configurations, parameters, rules, standards, etc. that the evidentiary data record may be required to fulfill or comply with in order to be linked or referenced by the evidentiary requirement. In this way, the one or more requisites may act as quality assurance parameters to ensure evidentiary data records that are linked to evidentiary requirements for a change request are suitable and comply with various regulations and policies. In this way, the overall storage and/or linkage to pertinent evidentiary data records may be streamlined such that evidentiary requirements do not reference or link to non-compliant evidentiary data records.

Additionally, embodiments described herein allow for the detection of improper evidentiary data records. Purely rules-based systems for tracking submitted evidence may be vulnerable to abuse as users figure out how to render certain rules ineffective. In contrast, example embodiments described herein may train an evidentiary requirement analysis machine learning models to infer requisites from patterns related to evidentiary requirements for a particular evidentiary domain. Thus, evidentiary requirement analysis machine learning models may be leveraged to identify submitted evidentiary data records that violate the evidentiary requirements for the particular evidentiary domain. In particular, a trained evidentiary requirement analysis machine learning model may be used to process the evidentiary data record and associated metadata to determine whether it satisfies one or more requisites, which the model has been configured with and/or inferred during training. By proactively identifying these non-compliant evidentiary data records, this may avoid associated downstream costs and delays necessary to correct such issues, thereby reducing overall computational resource usage and further reducing the expenditure of manual labor associated with verify evidentiary data records.

Additionally, in some embodiments contemplate automatically monitoring associated change request compliance with one or more institutional standards for a given change request type. These institutional standards may define expectations and/or temporal boundaries associated with a particular change request. As such, embodiments herein may monitor to determine whether particular milestones, deadlines, or other temporal goals are being exceeded or met. In an instance in which these expectations are not met or boundaries are exceeded, a violation alert may be provided to alert users of this violation. In some embodiments, an inference machine learning model may be trained using historical change request data and may automatically determine one or more of these institutional standards for a given institution or organization. The institutional machine learning model may be retrained and/or updated, such that it may automatically update institutional standards to reflect dynamic institutional standards.

Furthermore, embodiments described herein allow for scalability of change management activities. Although conventional techniques are limited by a quantity of human reviewers, embodiments described herein may also automatically update a status of an evidentiary requirement and/or perform a change implementation routine upon satisfaction of certain conditions in real-time or substantially real-time. By eliminating or reducing the need for manual review of each evidentiary data record and associated manual updated of individual evidentiary requirements, a significantly larger volume of change requests may be handled and implemented by an organization. Additionally, by automatically updating and monitoring a status of evidentiary requirements, embodiments described herein may automatically perform operations detailed in a change implementation routine to rollout the change for a change request in real time or substantially real-time. This may allow significantly shorter lead times in implementing changes. Additionally, the architecture allows for parallel processing for individual evidentiary data records and/or evidentiary data requirements. As such, the evidentiary data records may be processed and one or more evidentiary requirement statuses updated using one or more separate processing elements, computing entities, and/or the like. This allows for a reduction in the required computational time and the computational complexity of runtime operations on a single processing element and/or computing entity while still maintaining accuracy.

The foregoing brief summary is provided merely for purposes of summarizing some example embodiments described herein. Because the above-described embodiments are merely examples, they should not be construed to narrow the scope of this disclosure in any way. It will be appreciated that the scope of the present disclosure encompasses many potential embodiments in addition to those summarized above, some of which will be described in further detail below.

### BRIEF DESCRIPTION OF THE FIGURES

Having described certain example embodiments in general terms above, reference will now be made to the accompanying drawings, which are not necessarily drawn to scale. Some embodiments may include fewer or more components than those shown in the figures.

FIG. 1 illustrates a system in which some example embodiments may be used to manage evidentiary data about a change request.

FIG. 2 illustrates a schematic block diagram of example circuitry embodying a system device that may perform various operations in accordance with some example embodiments described herein.

FIG. 3 illustrates an example flowchart for generating a three-level data taxonomy, in accordance with some example embodiments described herein.

FIG. 4 illustrates an example flowchart for handling a received evidentiary data record, in accordance with some example embodiments described herein.

FIG. 5 illustrates an example flowchart for updating an evidentiary requirement using historical support containers, in accordance with some example embodiments described herein.

FIG. 6 illustrates an example flowchart for providing automatic violation alerts, in accordance with some example embodiments described herein.

FIG. 7 illustrates an example flowchart for providing requested evidentiary data records, in accordance with some example embodiments described herein.

FIG. 8 illustrates an example flowchart for handling an additional change request, in accordance with some example embodiments described herein.

FIG. 9 illustrates an example data taxonomy for a given project, in accordance with some example embodiments described herein.

FIG. 10 illustrates an example user interface of a change management interface used in some example embodiments described herein.

### DETAILED DESCRIPTION

Some example embodiments will now be described more fully hereinafter with reference to the accompanying figures, in which some, but not necessarily all, embodiments are shown. Because inventions described herein may be embodied in many different forms, the invention should not be limited solely to the embodiments set forth herein; rather, these embodiments are provided so that this disclosure will satisfy applicable legal requirements.

The term “computing device” refers to any one or all of programmable logic controllers (PLCs), programmable automation controllers (PACs), industrial computers, desktop computers, personal data assistants (PDAs), laptop computers, tablet computers, smart books, palm-top computers, personal computers, smartphones, wearable devices (such as headsets, smartwatches, or the like), and similar electronic devices equipped with at least a processor and any other physical components necessarily to perform the various operations described herein. Devices such as smartphones, laptop computers, tablet computers, and wearable devices are generally collectively referred to as mobile devices.

The term “server” or “server device” refers to any computing device capable of functioning as a server, such as a master exchange server, web server, mail server, document server, or any other type of server. A server may be a dedicated computing device or a server module (e.g., an application) hosted by a computing device that causes the computing device to operate as a server.

The term “change” refers to any alteration, modification, or implementation related to a project, which may be physical or virtual, within an organization. For example, a project may refer to a particular software, product, technology, etc. that is currently implemented or has a planned implementation within an organization. A change may be indicative of a new project implemented within the organization, such as implementation of a new product, software, technology, etc. A change may also be indicative of a new or upcoming version, update, or release, etc. of an existing project currently implemented within the organization.

### System Architecture

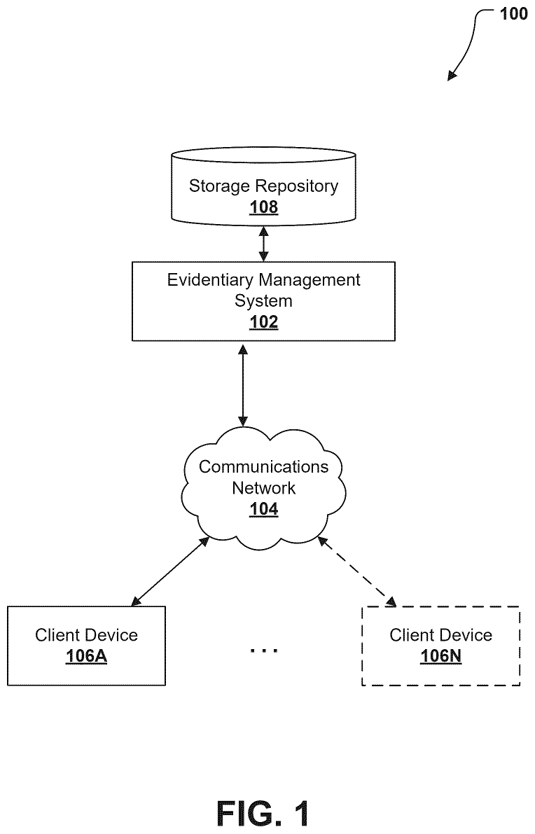

Example embodiments described herein may be implemented using any of a variety of computing devices or servers. To this end, FIG. 1 illustrates an example environment 100 within which various embodiments may operate. As illustrated, an evidentiary management system 102 may receive and/or transmit information via communications network 104 (e.g., the Internet) with any number of other devices, such as one or more of client devices 106A-106N. In some embodiments, the communications network 104 may be a private or restricted communication environment within which only certain, authorized devices may communication. In some embodiments, client devices 106A-106N may be authorized devices and may receive and/or transmit information with evidentiary management system 102 via trusted communications network 104. In some embodiments, a client device may be an authorized device only when an associated user is logged into an internal account environment that requires the user to provide a user identifier and user credentials to access and that these credentials be user be successfully authenticated for the user identifier. As such, client devices 106A-106N which may receive and/or transmit information with evidentiary management system 102 may be secure and trusted devices associated with an authenticated user (e.g., an employee or affiliate of the entity, institution, or organization associated with the evidentiary management system 102).

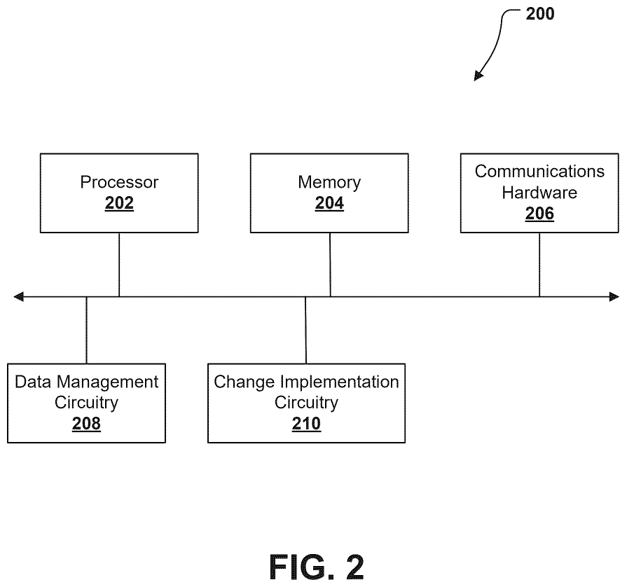

The evidentiary management system 102 may be implemented as one or more computing devices or servers, which may be composed of a series of components. Particular components of the evidentiary management system 102 are described in greater detail below with reference to apparatus 200 in connection with FIG. 2.

The one or more client devices 108A-108N may be embodied by any computing devices known in the art. The one or more client devices 106A-106N need not themselves be independent devices but may be peripheral devices communicatively coupled to other computing devices. In some embodiments, a client device (e.g., any one of client devices 106A-106N) may be associated with a user who is an authorized user associated with the evidentiary management system 102 (e.g., an employee or affiliate of the entity, institution, or organization associated with the evidentiary management system 102).

Although FIG. 1 illustrates an environment and implementation in which the evidentiary management system 102 interacts indirectly with a user via one or more of client devices 106A-106N, in some embodiments users may directly interact with the evidentiary management system 102 (e.g., via communications hardware of the evidentiary management system 102), in which case a separate user devices 106A-106N may not be utilized. Whether by way of direct interaction or indirect interaction via another device, a user may communicate with, operate, control, modify, or otherwise interact with the evidentiary management system 102 to perform the various functions and achieve the various benefits described herein.

In some embodiments, the evidentiary management system 102 further includes storage repository 108 that may comprise a distinct component from other components of the evidentiary management system 102. The storage repository 108 may be embodied as one or more direct-attached storage (DAS) devices (such as hard drives, solid-state drives, optical disc drives, or the like) or may alternatively comprise one or more Network Attached Storage (NAS) devices independently connected to a communications network (e.g., communications network 104). In some embodiments, storage repository 108 may host the software executed to operate the evidentiary management system 102. In some embodiments, the storage repository 108 may be hosted on the cloud by a cloud service. In some embodiments, the storage repository 108 may be a centralized storage location configured to store and maintain provided and/or received evidentiary data records. In some embodiments, the storage repository 108 may be configured with various security and/or access protocols which define various permissions and/or restrictions for client device (e.g., any one of client devices 106A-106N) and/or users (e.g., as indicated by his/her user credentials).

### Example Implementing Apparatuses

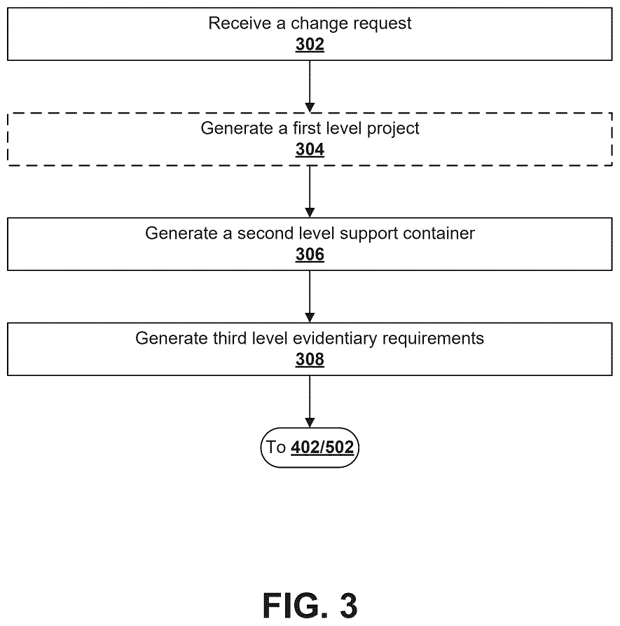

The evidentiary management system 102 (described previously with reference to FIG. 1) may be embodied by one or more computing devices or servers, shown as apparatus 200 in FIG. 2. The apparatus 200 may be configured to execute various operations described above in connection with FIG. 1 and below in connection with FIGS. 3-10. As illustrated in FIG. 2, the apparatus 200 may include processor 202, memory 204, communications hardware 206, data management circuitry 208, and change implementation circuitry 210, each of which will be described in greater detail below.

The processor 202 (and/or co-processor or any other processor assisting or otherwise associated with the processor) may be in communication with the memory 204 via a bus for passing information amongst components of the apparatus. The processor 202 may be embodied in a number of different ways and may, for example, include one or more processing devices configured to perform independently. Furthermore, the processor may include one or more processors configured in tandem via a bus to enable independent execution of software instructions, pipelining, and/or multithreading. The use of the term “processor” may be understood to include a single core processor, a multi-core processor, multiple processors of the apparatus 200, remote or “cloud” processors, or any combination thereof.

The processor 202 may be configured to execute software instructions stored in the memory 204 or otherwise accessible to the processor. In some cases, the processor may be configured to execute hard-coded functionality. As such, whether configured by hardware or software methods, or by a combination of hardware with software, the processor 202 represent an entity (e.g., physically embodied in circuitry) capable of performing operations according to various embodiments of the present invention while configured accordingly. Alternatively, as another example, when the processor 202 is embodied as an executor of software instructions, the software instructions may specifically configure the processor 202 to perform the algorithms and/or operations described herein when the software instructions are executed.

Memory 204 is non-transitory and may include, for example, one or more volatile and/or non-volatile memories. In other words, for example, the memory 204 may be an electronic storage device (e.g., a computer readable storage medium). The memory 204 may be configured to store information, data, content, applications, software instructions, or the like, for enabling the apparatus to carry out various functions in accordance with example embodiments contemplated herein.

The communications hardware 206 may be any means such as a device or circuitry embodied in either hardware or a combination of hardware and software that is configured to receive and/or transmit data from/to a network and/or any other device, circuitry, or module in communication with the apparatus 200. In this regard, the communications hardware 206 may include, for example, a network interface for enabling communications with a wired or wireless communication network. For example, the communications hardware 206 may include one or more network interface cards, antennas, buses, switches, routers, modems, and supporting hardware and/or software, or any other device suitable for enabling communications via a network. Furthermore, the communications hardware 206 may include the processing circuitry for causing transmission of such signals to a network or for handling receipt of signals received from a network.

The communications hardware 206 may further be configured to provide output to a user and, in some embodiments, to receive an indication of user input. In this regard, the communications hardware 206 may comprise a user interface, such as a display, and may further comprise the components that govern use of the user interface, such as a web browser, mobile application, dedicated client device, or the like. In some embodiments, the communications hardware 206 may include a keyboard, a mouse, a touch screen, touch areas, soft keys, a microphone, a speaker, and/or other input/output mechanisms. The communications hardware 206 may utilize the processor 202 to control one or more functions of one or more of these user interface elements through software instructions (e.g., application software and/or system software, such as firmware) stored on a memory (e.g., memory 204) accessible to the processor 202.

In addition, the apparatus 200 further comprises a data management circuitry 208 that may be configured to generate a first level project, generate second level support container and/or non-development tasks, generate third level evidentiary requirements and/or non-development task requirements. In some embodiments, the data management circuitry 208 may further be configured to identify an evidentiary requirement associated with an evidentiary data records, determine whether the evidentiary data record satisfies requisites for the evidentiary requirement, determine at least one tag associated with the evidentiary data record, store the evidentiary data record in a designated storage repository, update the identifier evidentiary requirement to reference the evidentiary data record, update a status for the evidentiary requirement, and/or the like. In some embodiments, the data management circuitry 208 may further be configured to determine whether the project identifier is referenced by a historical support container, select an evidentiary requirement, identify a historical evidentiary requirement, identify a historical evidentiary data record referenced by the historical evidentiary requirement, determine whether the historical evidentiary data record satisfies the requisites for the evidentiary requirement, and/or the like. The data management circuitry 208 may further be configured to determine one or more institutional standards for a change request type, determine whether a violation of an institutional standard has occurred, and/or the like. The data management circuitry 208 may further be configured to determine a storage location of requested evidentiary data records as indicated by an evidentiary data record request. The data management circuitry 208 may utilize processor 202, memory 204, or any other hardware component included in the apparatus 200 to perform these operations, as described in connection with FIGS. 3-10 below. The data management circuitry 208 may further utilize communications hardware 206 to gather data from a variety of sources (e.g., client device 106A through client device 106N or storage repository 108, as shown in FIG. 1), and/or exchange data with a user, and in some embodiments may utilize processor 202 and/or memory 204 to execute various models such as but not limited to an evidentiary requirement analysis machine learning model, a tagging model, an inference machine learning model, and/or the like to perform these operations.

In addition, the apparatus 200 further comprises a change implementation circuitry 210 that may be configured to determine whether each evidentiary requirement is associated with a completed status, perform a change implementation routine, and/or the like. The change implementation circuitry 210 may utilize processor 202, memory 204, or any other hardware component included in the apparatus 200 to perform these operations, as described in connection with FIGS. 3-9 below. The change implementation circuitry 210 may further utilize communications hardware 206 to gather data from a variety of sources (e.g., client devices 106A-106N as shown in FIG. 1), and/or exchange data with a user, and in some embodiments may utilize processor 202 and/or memory 204 to perform one or more operations described by the change implementation routine to implement all or part of the change or direct one or more individuals and/or systems to implement the change.

Although components 202-210 are described in part using functional language, it will be understood that the particular implementations necessarily include the use of particular hardware. It should also be understood that certain of these components 202-210 may include similar or common hardware. For example, the data management circuitry 208 and the change implementation circuitry 210 may each at times leverage use of the processor 202, memory 204, or communications hardware 206, such that duplicate hardware is not required to facilitate operation of these physical elements of the apparatus 200 (although dedicated hardware elements may be used for any of these components in some embodiments, such as those in which enhanced parallelism may be desired). Use of the term “circuitry” with respect to elements of the apparatus therefore shall be interpreted as necessarily including the particular hardware configured to perform the functions associated with the particular element being described. Of course, while the term “circuitry” should be understood broadly to include hardware, in some embodiments, the term “circuitry” may in addition refer to software instructions that configure the hardware components of the apparatus 200 to perform the various functions described herein.

Although the data management circuitry 208 and the change implementation circuitry 210 may leverage processor 202, memory 204, or communications hardware 206 as described above, it will be understood that either of the data management circuitry 208 and the change implementation circuitry 210 may include one or more dedicated processor, specially configured field programmable gate array (FPGA), or application specific interface circuit (ASIC) to perform its corresponding functions, and may accordingly leverage processor 202 executing software stored in a memory (e.g., memory 204), or communications hardware 206 for enabling any functions not performed by special-purpose hardware. In all embodiments, however, it will be understood that the data management circuitry 208 and the change implementation circuitry 210 comprise particular machinery designed for performing the functions described herein in connection with such elements of apparatus 200.

### Example Operations

Turning to FIGS. 3-8, example flowcharts are illustrated that contain example operations implemented by example embodiments described herein. The operations illustrated in FIGS. 3-8 may, for example, be performed by the evidentiary management system 102 shown in FIG. 1, which may in turn be embodied by an apparatus 200, which is shown and described in connection with FIG. 2. To perform the operations described below, the apparatus 200 may utilize one or more of processor 202, memory 204, communications hardware 206, data management circuitry 208, change implementation circuitry 210, and/or any combination thereof. It will be understood that user interaction with the evidentiary management system 102 may occur directly via communications hardware 206 or may instead be facilitated by a separate client device 106A-106N, as shown in FIG. 1, and which may have similar or equivalent physical componentry facilitating such user interaction.

### Example Operations for Generating a Three Level Data Taxonomy

Turning first to FIG. 3, example operations are shown for generating a three-level data taxonomy to handle a change request. In order to handle a change request, the apparatus 200 may define a three-level data taxonomy. Here, a first (highest) level is associated with a particular project and the project may be assigned a project identifier. This project identifier may act as the key (e.g., a foreign key) for a subsequent, lower level to create and maintain the hierarchical relationship between levels. Next, a second level may be associated with a support container and in some embodiments, one or more divisible non-development tasks for the project. This mid-tier support container may be configured to aggregate and organize all evidentiary data records, such that this evidence is easily accessible to pertinent parties. The support container and non-development tasks may reference the project identifier such that the relationship between the levels is created. The support container may also be assigned a support container identifier, and each non-development task may be assigned a non-development task identifier. The support container identifier and non-development task identifiers may act keys (e.g., foreign keys) for a subsequent, lower level to again, create and maintain the hierarchical relationship between levels. Finally, a third level may be associated with one or more evidentiary requirements, which each are associated with a particular evidentiary domain and optionally, one or more non-development task requirements. The evidentiary requirements may each reference the support container identifier and each non-development task requirement may reference a particular non-development task identifier. Here, the evidentiary requirements may reference or link to associated evidentiary data records. As such, the data taxonomy described herein provides for transparent and efficient aggregation of evidentiary data records, thereby allowing for evidentiary data record association with the higher-level project for a change request as well as lower-level evidentiary requirements. Thus, the data taxonomy contemplated herein provides for a more efficiently structured change management architecture that is more computationally and space efficient by eliminating the need for users to search for evidentiary data records post hoc. Furthermore, this three-level data taxonomy may be implemented within an agile project management workflow and may allow for iterative change implementation for a given project in a flexible manner.

As shown by operation 302, the apparatus 200 may include means, such as processor 202, memory 204, communications hardware 206, data management circuitry 208, or the like, for receiving a change request. A change request may be indicative of an upcoming change (e.g., a new version, release, or update) for an existing project (e.g., software, product, technology) or may be indicative of the implementation of a new project. Receipt of the change request may therefore be indicative for the data management circuitry 208 to define a three-level data taxonomy for the associated change. In particular, the three-level data taxonomy may define a first level project and organize a second level support container and/or non-development tasks under the project. As described in further detail below, the support container may be configured to reference and/or link to associated evidentiary data records associated with the project for a particular change request. Thus, these evidentiary data records are easily accessible to pertinent parties and may be secured stored.

The change request may include a project identifier that can be used to identify a project to which the change request corresponds. The project identifier may uniquely identify a particular project such that it is distinguishable from other projects. For example, the project identifier may be any combination of alphabetical, numerical, and/or special characters that are unique to the project. If the change request corresponds to an existing project, the included project identifier may already be defined for the project. If the change request pertains to a new project (e.g., not currently implemented), the project may not yet be associated with a project identifier. In some embodiments, a user providing the change request may create and provide a candidate project identifier for the project in the change request. The data management circuitry 208 may be configured to determine whether the candidate project identifier is available and/or whether it complies with one or more policy rules. If the data management circuitry 208 determines the candidate project identifier is compliant and available, it may assign the candidate project identifier as the project identifier for the project. Otherwise, the data management circuitry 208 may request the user provide a different candidate project identifier and/or may offer available and compliant alternative project identifiers via communications hardware 206. The user may then provide an updated change request that includes an updated candidate project identifier. This may be an iterative process that repeats until the user provides a compliant and available candidate project identifier. Thus, the change request may indicate the project to which the change request corresponds.

Additionally, the change request may include a change request type. In some embodiments, each type of change may be associated with a defined category of a change request type. For example, a change request type may be a new project, a new version, a new release, a new update, and/or the like. Each defined category of change request type may further be associated with a schema that may define evidentiary requirements for a support container. In some embodiments, the schema may further define one or more non-development tasks and/or non-development task requirements for a given change request. It will be appreciated that different change request types may include different evidentiary requirements. In some embodiments, the evidentiary requirements associated with a particular change request type may be defined by an authorized user, such as an administrator or manager. The evidentiary requirements associated with the change request type may be stored and/or maintained in an associated memory accessible to apparatus 200, such as memory 204.

In some embodiments, the communications hardware 206 may receive the change request from a client device (e.g., any one of client devices 106A-106N). In some embodiments, receiving the change request may be accomplished via a wired or wireless connection and may be performed by the communications hardware 206. For example, a wireless interface card may receive a stream of data packets containing an encrypted change request divided among payloads of several packets. Payloads of these packets may be decrypted and assembled (not necessarily in that order) to reconstruct the change request. The change request may then be passed to the data management circuitry 208 for processing. In another example, a network interface may receive a stream of data via a wired connection containing a change request in an unencrypted form. This data may be parsed, and/or the data may be passed through the communications hardware 206 to the data management circuitry 208 for processing.

Optionally, as shown by operation 304, the apparatus 200 may include means, such as processor 202, memory 204, data management circuitry 208, or the like, for generating a first level project. In some embodiments, a first level may not currently exist or be defined for a project, such as in instances where the change is for a new project implementation. Thus, in some embodiments, the data management circuitry 208 may generate a first level project in response to receipt of the change request and upon determination that no first level project currently exists for the project identifier.

In some embodiments, the data management circuitry 208 may generate the first level project by generating a new record within a designated database. The first level project may be assigned the project identifier included in the change request. This project identifier may be used to create and maintain the hierarchical relationships between subsequent levels (e.g., support containers and/or non-development tasks). In some embodiments, the data management circuitry 208 may use an evidentiary management database to store and maintain the various records levels of the data taxonomy. In some embodiments, the evidentiary management database may be stored and/or maintained within storage repository 108.

In some embodiments, the evidentiary management database is a relational database or a structured language query (SQL) database and may use any suitable relational database management system (RDBMS) to store data in a table-oriented format. In some embodiments, the evidentiary management database may be a non-relational database or NoSQL database and may store data in document formats, as a collection of key-value pairs, in tables with dynamic rows and/or columns, as a graph, etc. In some embodiments, the evidentiary management system may be an object-oriented database that may store data in the form of objects. Alternatively, the evidentiary management system may be a hybrid or any one or more of relational databases, non-relational databases, object-oriented databases, and/or the like.

Data management circuitry 208 may generate and format the new record for the project within the evidentiary management database based on the type of database of the evidentiary management database. For example, if the evidentiary management database is a relational database, the data management circuitry 208 may generate the project as a record in a table. In some embodiments, the project may be a row within the table and may further include one or more columns. The columns may describe the overall project and/or pertinent high-level project information. For example, the columns for the project may include the project identifier and a project name. As described in further detail below, the project identifier may be used as a key (e.g., a foreign key) such that it uniquely identifies each project (e.g., row) within the table. Alternatively, the record may be formatted as a document, table, key-value pair, graph, etc. for a non-relational database. For object-oriented databases, the record may be formatted as an object and the object may include various attributes, such as a project identifier attribute and project name attribute.

Alternatively, in some embodiments, a first level project may currently exist for the project indicated in the change request. For example, the previous change requests may have been received for the project such that the project is already defined in a first level of an evidentiary management database. In such an instance, the data management circuitry 208 may identify the first level project within the evidentiary management database using the project identifier included in the change request. If the data management circuitry 208 determines that a project identifier of a record within the evidentiary management database matches the provided project identifier, the data management circuitry 208 may determine the first level project already exists. The data management circuitry 208 may use the project identifier as the key to maintain the relationship to the first level project.

As shown by operation 306, the apparatus 200 may include means, such as processor 202, memory 204, data management circuitry 208, or the like, for generating a second level support container for the change request. Once communications hardware 206 receives the change request, the data management circuitry 208 may determine the change request type described by the change request. As discussed above, a change request type may be associated with a schema that defines a support container format or template indicative of the associated evidentiary requirements for the support container. In some embodiments, the schema of the change request may additionally be associated with one or more non-development tasks and associated non-development task requirements for a given change request type. For example, a change request type may be a new project, a new version, a new release, a new update, and/or the like. The data management circuitry 208 may generate the second level support container and optionally, second level non-development tasks for the change request based on the change request type.

As described above, in some embodiments, the evidentiary management database may be associated with one or more schema that are each associated with a change request type. The schema may define the structure and/or format of second level and/or third level components for the given change request. For example, the schema may define a support container to be generated for the change request and as discussed in greater detail in operation 308, the schema may further define one or more associated third level evidentiary requirements for change request type. Additionally, in some embodiments, the schema may define one or more non-development tasks and one or more non-development task requirements for a given change request type. A non-development task may pertain to a category of operations that fall outside of evidentiary data record aggregation that is associated with the project but are still required for the change request and/or project.

The data management circuitry 208 may identify the appropriate schema to use based on the change request type and then may generate the support container and optionally, one or more second level non-development tasks based on the schema associated with the change request type. In this way, the resulting support container and evidentiary requirements created for the change request may be flexible and considerate of the requirements and needs for different change request types. For example, a schema for a new project change request type may define a support container with ten evidentiary requirements but a schema for a new version change request type may only define seven evidentiary requirements. Here, the three evidentiary requirements defined in the support container for the new project change request type but not in the new version change request may be associated with evidentiary domains that are specific to new projects and may have heightened documentation or security requirements, require evidence from a greater number of individuals or departments, etc. However, these evidentiary domains and associated evidentiary requirements may not be needed for new version change request and thus may be excluded. Therefore, the use of schema for different change request types allows for flexibility in the generation of third level evidentiary requirements which reference a second level support container and/or other second level non-development tasks.

The data management circuitry 208 may generate a second level support container, which may be a component, module, logical grouping, or structure configured to aggregate and maintain evidentiary data records associated with the change request. The support container may be configured to aggregate all evidentiary data records related to the change request. In some embodiments, the data management circuitry 208 may generate the support container by generating a new record that referenced the first level project within the evidentiary management database. In some embodiments, the data management circuitry 208 may generate and format the support container based on the type of database of the evidentiary management database. For example, if the evidentiary management database is a relational database, the data management circuitry 208 may generate the support container as a record in a table. This table may be the same table as the table storing the first level project (e.g., a single table approach) or within a new table (e.g., a multiple tables approach). In some embodiments, the support container may be a row within the table and may further include one or more columns. Columns for a support container may include a support container name and a unique support container identifier, which may uniquely identify the support container from other second level non-development tasks and/or support containers. In some embodiments, the data management circuitry 208 may automatically generate and assign a support container identifier using any suitable algorithm.

The support container columns may include an indication of hierarchical relationship information. For example, a column for a support container may include the associated project identifier. This project identifier may serve as a key (e.g., a foreign key) and may further designate the relationship between the first level project and the second level support container. That is, the project identifier column for the support container may serve as a reference to the higher-level project. Furthermore, in some embodiments, a column for the support container may further include a change identifier that may uniquely identify the associated change request. This may allow for a first level project to be associated with multiple change requests and may serve to easily differentiate non-development tasks and/or support containers belonging to different change requests. Alternatively, the record may be formatted as a document, table, key-value pair, graph, etc. for a non-relational database. For object-oriented databases, the record may be formatted as an object and the object may include various attributes, such as a support container name attribute, support container identifier attribute, project identifier attribute, and change identifier attribute.

Optionally, in some embodiments, the data management circuitry 208 may generate other second level non-development tasks by generating a new record for each non-development task in the associated set of non-development tasks within the evidentiary management database. The data management circuitry 208 may generate and format the records for each non-development task within the evidentiary management database based on the type of database of the evidentiary management database. For example, if the evidentiary management database is a relational database, the data management circuitry 208 may generate the non-development tasks as a record in a table. In some embodiments, each non-development task may be a row within the table and may further include one or more columns. The columns may describe the non-development task and furthermore, may include an indication of project relational information. For example, the columns for a non-development task may include a non-development task name and a unique non-development task identifier, which may uniquely identify the non-development task from other second level non-development tasks. In some embodiments, the data management circuitry 208 may automatically generate and assign each non-development task a unique non-development task identifier using any suitable algorithm. Additionally, a column for a non-development task may include the associated project identifier. This project identifier may serve as a key (e.g., a foreign key) and may further designate the relationship between the first level project and a second level non-development task. Furthermore, in some embodiments, a column for a non-development task may further include a change identifier that may uniquely identify the associated change request. Alternatively, the record may be formatted as a document, table, key-value pair, graph, etc. for a non-relational database. For object-oriented databases, the record may be formatted as an object and the object may include various attributes, such as a non-development task name attribute, non-development task identifier attribute, project identifier attribute, and change identifier attribute.

Finally, as shown by operation 308, the apparatus 200 may include means, such as processor 202, memory 204, communications hardware 206, data management circuitry 208, or the like, for generating one or more third level evidentiary requirements. Once the data management circuitry 208 has generated the second level support container, it may further generate the third level evidentiary requirements and optionally, one or more non-development task requirements. Each evidentiary requirement may pertain to a particular evidentiary domain and may be associated with a status that is indicative of whether the evidentiary requirement is completed or still requires additional evidentiary data records. For example, an evidentiary requirement status may be not started, in progress, complete, and/or the like.

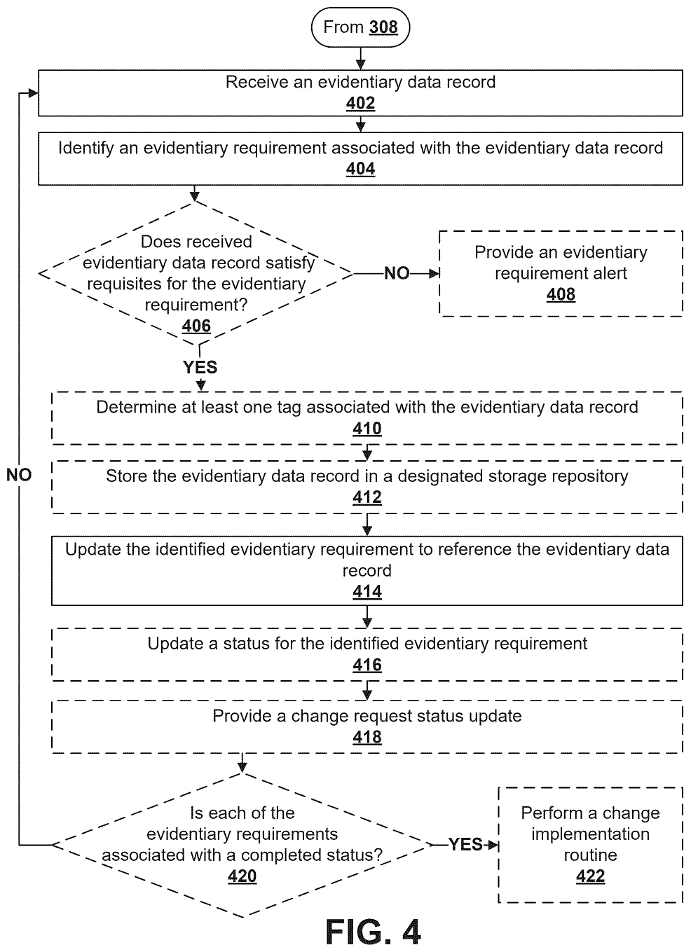

In some embodiments, an evidentiary requirement may be associated with one or more requisites and/or one or more record requirements. As described in further detail in FIG. 4, the one or more requisites may define one or more configurations, parameters, rules, standards, etc. that an evidentiary data record may be required to fulfill or comply with in order to be linked or referenced by the evidentiary requirement. Additionally, the one or more record requirements may describe conditions, circumstances, or the like under which the evidentiary requirement is considered to be complete.

Each evidentiary requirement may also be associated with a particular discretized evidentiary domain. An evidentiary domain may be directed to different purposes or goals to ensure policy, governance, customer readiness compliance. An evidentiary domain may further be handled or managed by different individuals, departments, etc. within an organization.

As discussed above, the data management circuitry 208 may identify a schema for the change request type and may generate the second level support container based on the schema. The schema may define one or more evidentiary requirements, each associated with an evidentiary domain, for the support container for a given change request type. Thus, the data management circuitry 208 may generate the one or more third level evidentiary requirements for the second level support container based on the schema for the change request type.

The data management circuitry 208 may generate the third level evidentiary requirements for the second level support container and these evidentiary requirements may reference or link to associated evidentiary data records relevant to the change request. As such, relevant evidentiary data records (e.g., data, documents, and/or other pertinent information) may be aggregated within the defined three-level data taxonomy and furthermore, may be categorized based on the corresponding evidentiary domain.

In some embodiments, the data management circuitry 208 may generate and format the one or more evidentiary requirements based on the type of database of the evidentiary management database. For example, if the evidentiary management database is a relational database, the data management circuitry 208 may generate the one or more evidentiary requirements as a record in a table. This table may be the same table as the table storing the first level project and second level support container (e.g., a single table approach) or within a new table (e.g., a multiple tables approach). In some embodiments, the one or more evidentiary requirements may each be a row within the table and may further include one or more columns. A column for an evidentiary requirement may include a unique evidentiary requirement identifier, which may uniquely identify the evidentiary requirement from other third level evidentiary requirements and/or non-development task requirements. In some embodiments, the data management circuitry 208 may automatically generate and assign an evidentiary requirement identifier using any suitable algorithm. Additionally, a column for an evidentiary requirement may further include an indication of the associated evidentiary domain. For example, a value for an evidentiary domain column may include a categorical name, a one-hot encoded value, and/or the like.

Columns for the evidentiary requirements may also include an indication of hierarchical relationship information. For example, a column for an evidentiary requirement may reference or include the associated support container identifier. The support container identifier may serve as a key (e.g., a foreign key) and may further designate the relationship between the second level support container and the third level support evidentiary requirement. That is, the support container identifier column for the evidentiary requirement may serve as a reference to the second level support container, and the second level support container may reference the first level project. Thus, each of the three levels are connected and the relationship maintained via the hierarchical references within each associated record. Alternatively, the record may be formatted as a document, table, key-value pair, graph, etc. for a non-relational database. For object-oriented databases, the record may be formatted as an object and the object may include various attributes, such as an evidentiary requirement identifier attribute, evidentiary requirement domain attribute, support container identifier attribute, evidentiary data record linkage attributes, and a status attribute.

Columns for an evidentiary requirement may also provide a reference or link to evidentiary data records, which may be stored in various locations. In some embodiments, each link to an evidentiary data record may correspond to a column within the record for the evidentiary requirement. In some embodiments, an evidentiary requirement may have a dynamic number of columns to allow for responsive and flexible linkages of the evidentiary requirement to any number of relevant evidentiary data records. In some embodiments, the evidentiary data records may be stored in any number of storage systems, computer desktops, computer applications, etc. and the evidentiary requirement may store a reference or link to the evidentiary data record at these locations. In some embodiments, responsive to a user providing an evidentiary data record, the evidentiary data record may be stored in a designated storage repository, such as storage repository 108. Referencing or linking provided evidentiary data records to an evidentiary requirement will be discussed in greater detail in FIG. 4.

Optionally, in some embodiments the schema may further define one or more non-development task requirements for a given change request type. Thus, the data management circuitry 208 may generate the one or more third level non-development task requirements for one or more second non-development tasks based on the schema for the change request type.

In some embodiments, the data management circuitry 208 may generate and format the one or more non-development task requirements based on the type of database of the evidentiary management database. For example, if the evidentiary management database is a relational database, the data management circuitry 208 may generate the one or more non-development task requirements as a record in a table. This table may be the same table as the table storing the first level project and support container and non-development tasks (e.g., a single table approach) or within a new table (e.g., a multiple tables approach). In some embodiments, the one or more non-development task requirements may each be a row within the table and may further include one or more columns. A column for a non-development task may include a unique non-development task requirement identifier, which may uniquely identify the non-development task requirement from other third level evidentiary requirements and/or non-development task requirements. In some embodiments, the data management circuitry 208 may automatically generate and assign a non-development task requirement identifier using any suitable algorithm.

Columns for the non-development task requirements may also include an indication of hierarchical relationship information. For example, a column for a non-development task requirement may reference or include the associated non-development task identifier. The non-development task identifier may serve as a key (e.g., a foreign key) and may further designate the relationship between the second level non-development task and the third level non-development task requirement. That is, the non-development task identifier column for the non-development task requirement may serve as a reference to the second level non-development task, and the second level non-development task may reference the first level project. Thus, each of the three levels are connected and the relationship maintained via the hierarchical references within each associated record. Alternatively, the record may be formatted as a document, table, key-value pair, graph, etc. for a non-relational database. For object-oriented databases, the record may be formatted as an object and the object may include various attributes, such as a non-development task requirement identifier attribute and non-development task identifier attribute.

### Example Operations for Handling Received Evidentiary Data Records

Turning now to FIG. 4, example operations are shown for managing received evidentiary data records. In some embodiments, after a change request has been received, the apparatus 200 may receive evidentiary data record from client devices. An evidentiary data record may serve as evidence of compliance with established internal policies and procedures, governmental and/or institutional regulations, and/or or other organizational readiness activities. These received evidentiary data records may pertain to an evidentiary requirement of a given evidentiary domain. The relevant evidentiary requirement may be updated to reference or link to the received evidentiary data record such that these evidentiary data records, which serve as evidence of compliance for a given change request, are traceable and accessible.

As shown by operation 402, the apparatus 200 may include means, such as processor 202, memory 204, communications hardware 206, data management circuitry 208, or the like, for receiving an evidentiary data record. An evidentiary data record may be a document, media, file, or other data that may pertain to the change request. An evidentiary data record may serve as support or evidence that of completion or compliance with a particular evidentiary requirement of an associated evidentiary domain. Thus, an evidentiary data record may serve as evidence of compliance with established internal policies and procedures, governmental and/or institutional regulations, and/or or other organizational readiness activities. In some embodiments, an evidentiary data record, alone or alongside other evidentiary data records may satisfy record requirements associated with a given evidentiary requirement such that the status of the evidentiary requirement may be updated, manually or automatically as described in operation 416, to indicate it is complete.

In some embodiments, the received evidentiary data record may be indicative of a location of where the evidentiary data record is currently stored. For example, the evidentiary data record may be stored on storage system, computer desktop, computer application, etc. The received evidentiary data record may therefore be a link to the storage location of the evidentiary data record. Additionally, or alternatively, the received evidentiary data record may include the evidentiary data record itself. In some embodiments, the data management circuitry 208 may store the received evidentiary data record in a designated storage repository. The designated storage repository may be a central storage repository accessible to apparatus 200 and/or designated users, such as storage repository 108. The designated storage repository may serve as a central location for storing evidentiary data records. The evidentiary data records stored by the designated storage repository may be used as the primary location or may serve as a back-up location as a failsafe for issues with the primary storage location, such as if the original storage location and/or stored evidentiary data record becomes inaccessible. In some embodiments, the evidentiary data record may directly be stored in the designated storage repository such that the original storage location is the designated storage repository.

In some embodiments, the communications hardware 206 may receive the evidentiary data record from a client device (e.g., any one of client devices 106A-106N). For example, an authorized user (e.g., a software developer, administrator, employee, or the like) may submit an evidentiary data record in support of a particular evidentiary requirement for a project. The received evidentiary data record may include an indication of the project identifier, change identifier, support container identifier, and/or evidentiary requirement identifier. The received evidentiary data record may also include an indication of the evidentiary domain to which the evidentiary data record pertains.

In some embodiments, the received evidentiary data record may only include the evidentiary requirement identifier. In such an instance, the associated higher-level support container is determinable based on the support container identifier defined in the evidentiary requirement (e.g., a value for the support container identifier column), which may serve as the foreign key. Similarly, the higher-level project is also determinable based on the project identifier defined in the support container (e.g., a value for the project identifier column), which may also serve as the foreign key. Additionally, in some embodiments, the evidentiary data record may include associated data and/or metadata indicative of the submitting user or department, evidentiary data record generation date and time, a file or data type or format, security restrictions and/or permissions, and/or the like.

Receiving the evidentiary data record may be accomplished via a wired or wireless connection, the evidentiary data record may be received in any format, and the receiving may be performed by the communications hardware 206. For example, a wireless interface card may receive a stream of data packets containing an encrypted portable document format (PDF) file of an evidentiary form divided among payloads of several packets. Payloads of these packets may be decrypted and assembled (not necessarily in that order) to reconstruct the PDF file. The evidentiary data record in the form of the PDF file may then be passed to the data management circuitry 208 for processing. In another example, a network interface may receive a stream of data via a wired connection containing a plain text evidentiary data record (e.g. a log file) in an unencrypted form. This data may be parsed, and/or the data may be passed through the communications hardware 206 to the data management circuitry 208 for processing.

As shown by operation 404, the apparatus 200 may include means, such as processor 202, memory 204, data management circuitry 208, or the like, for identifying an evidentiary requirement associated with the evidentiary data record. As described above, in some embodiments, the received evidentiary data record may include an indication of the evidentiary requirement identifier. As such, the data management circuitry 208 may automatically identify the evidentiary requirement to which the evidentiary data record pertains using the provided evidentiary requirement identifier. In some embodiments, the evidentiary requirement identifier may be selected by the submitting user.

In some embodiments, the received evidentiary data record may include an indication of the project identifier, change identifier, support container identifier, but not the evidentiary requirement identifier. In such an instance, the received evidentiary data record may also include the evidentiary domain to which the evidentiary data record pertains. As such, the data management circuitry 208 may identify the evidentiary requirement by using one of the provided identifiers (e.g., project identifier, change identifier, and/or support container identifier) and the evidentiary domain, which is associated with a particular evidentiary requirement.

In some embodiments, the evidentiary data record may pertain to more than one evidentiary requirement. In such an instance, the data management circuitry 208 may identify one or more evidentiary requirements for the evidentiary data record. In such an instance, the received evidentiary data record may include one or more evidentiary requirement identifiers. Alternatively, the received evidentiary data record may include a single identifier (e.g., project identifier, change identifier, and/or support container identifier) and one or more evidentiary domains. The data management circuitry 208 may then identify the one or more evidentiary requirements in the same manner as described above.

Optionally, as shown by operation 406, the apparatus 200 may include means, such as processor 202, memory 204, data management circuitry 208, or the like, for determining whether the evidentiary data record satisfies one or more requisites associated with the evidentiary requirement. As described above, an evidentiary requirement may be associated with a particular evidentiary domain. In some embodiments, the evidentiary requirement may further be associated with one or more requisites that describe rules and/or conditions for a given evidentiary data record in order for it to be compliant with the associated evidentiary domain policies and/or procedures. In some embodiments, the one or more requisites for a given evidentiary requirement may be defined within the schema or may be configured in an associated memory, such as memory 204. Thus, the data management circuitry 208 may determine the one or more requisites for the evidentiary requirement identified in operation 404.

In some embodiments, the one or more requisites for the evidentiary requirement may define one or more configurations, parameters, rules, standards, etc. that the evidentiary data record may be required to fulfill or comply with in order to be linked or referenced by the evidentiary requirement. In this way, the one or more requisites may act as quality assurance parameters to ensure evidentiary data records that are linked to evidentiary requirements for a change request are suitable and comply with various regulations and policies. In this way, the overall storage and/or linkage to pertinent evidentiary data records may be streamlined such that evidentiary requirements do not reference or link to non-compliant evidentiary data records.

In some embodiments, the one or more requisites for a given evidentiary requirement may define acceptable file type extensions or formats for the evidentiary data records, users or department authorized to provide evidentiary data records, acceptable title formats, file size restrictions or requirements, security protocol requirements (e.g., encryption standards), signatures required within the evidentiary data records, acceptable page count ranges, required text or data content within the evidentiary data record (e.g., required keywords or phrases, confirmations of performance of tasks, feedback, and/or the like), etc. In some embodiments, the data management circuitry 208 may be configured to automatically determine whether the evidentiary data record satisfies one or more of the one or more requisites for the evidentiary requirement. For example, the data management circuitry 208 may be configured to process the evidentiary data record metadata to determine whether one or more requisites are satisfied.

In some embodiments, the data management circuitry 208 may use an evidentiary requirement analysis machine learning model to determine whether the evidentiary data record satisfies one or more requisites. The evidentiary requirement analysis machine learning model may be a large language model (LLM), a suitable neural network (e.g., a recurrent neural network (CNN), long short-term memory (LSTM), or the like), or transformer model (e.g., bidirectional encoder representations from transformers (BERT)) configured to process an evidentiary data record and determine whether the one or more requisites for a given evidentiary requirement are satisfied.

In some embodiments, the evidentiary requirement analysis machine learning model is configured with a set of static rules and is further trained to optimize various parameters. In some embodiments, the evidentiary requirement analysis machine learning model is trained using a supervised learning approach. In particular, the evidentiary requirement analysis machine learning model may be trained using a training evidentiary data record set. The training evidentiary data record set may include one or more evidentiary data records that are labelled with the associated evidentiary requirement and further, are labelled as compliant or non-compliant. Evidentiary data records labelled as non-compliant may further provide an indication of the offending issue (e.g., non-complaint or missing title, non-compliant or missing signatures, non-compliant or missing keywords or phrases, non-compliant or missing confirmation of completion of various tasks, and/or the like). As such, the evidentiary requirement analysis machine learning model may be trained to process metadata and the evidentiary data record itself to determine whether the one or more defined and learned requisites for a given evidentiary requirement are satisfied.

Additionally, or alternatively, in some embodiments, the evidentiary requirement analysis machine learning model is trained using an unsupervised training approach. Here, the evidentiary data records may be provided to the evidentiary requirement analysis machine learning model but may not be labelled with an indication of whether they are compliant or non-compliant. The evidentiary data records may be indicative of the evidentiary requirement to which they are associated, but this need not necessarily be indicated with a label and rather may be indicated in the metadata or evidentiary data record itself. The evidentiary requirement analysis machine learning model may employ various techniques, such as clustering algorithms (e.g., K-means, latent Dirichlet allocation (LDA), density-based spatial clustering of applications with noise (DBSCAN), or the like), to infer the one or more requisites for a given evidentiary data record. In some embodiments, the evidentiary requirement analysis machine learning model may be trained using a hybrid involving both a supervised learning and unsupervised learning approach. In some embodiments, a supervised learning approach is applied first and then an unsupervised learning approach is applied. Alternatively, the unsupervised learning approach may be applied before and the supervised learning approach is applied.

In an instance in which the evidentiary data record fails to satisfy a requisite for the evidentiary requirement, the process may proceed to operation 408. Optionally, as shown by operation 408, the apparatus 200 may include means, such as processor 202, memory 204, communications hardware 206, data management circuitry 208, or the like, for providing an evidentiary requirement alert. If the evidentiary data record fails to satisfy a requisite of the evidentiary requirement, the data management circuitry 208 may provide an evidentiary requirement alert to an end user and/or an administrator. The evidentiary requirement alert may be indicative that the evidentiary data record received in operation 402 fails to comply with one or more requisites for the indicated evidentiary requirement. Additionally, the evidentiary requirement alert may provide an indication of the one or more requisites which the evidentiary data record failed to satisfy. As such, the recipient user of the evidentiary requirement alert may be informed of how to remedy or resolve the issue. In some instances, this failure is due to a non-compliance or issue with the evidentiary data record such that the user must update the evidentiary data record itself. Alternatively, this failure may be due to an incorrect indication of the evidentiary requirement to which the evidentiary data record pertains such that the user may simply resubmit the evidentiary data record with the correct evidentiary requirement.

The data management circuitry 208 may generate the evidentiary requirement alert and may use communications hardware 206 to provide the evidentiary requirement alert to one or more client devices (e.g., any one of client devices 106A-106N). In particular, the data management circuitry 208 may provide the evidentiary requirement alert to the client device from which the evidentiary data record was received. Additionally, in some embodiments, the data management circuitry 208 may be configured with one or more client devices to provide the evidentiary requirement alert for a given evidentiary requirement. For example, a given evidentiary requirement may be associated with a particular department and the data management circuitry 208 may be configured to provide the evidentiary requirement alert to one or more users within the particular department (e.g., managers, administrators, or the like) such that these users may be aware of potential issues.

In an instance in which the evidentiary data record satisfies the one or more requisites for the evidentiary requirement, the process may proceed to operation 410. Optionally, as shown by operation 410, the apparatus 200 may include means, such as processor 202, memory 204, data management circuitry 208, or the like, for determining at least one tag associated with the evidentiary data record. In some embodiments, in addition to linking or referencing the evidentiary data record in the evidentiary requirement as described in operation 414, the evidentiary data record itself may be updated to include one or more tags. The one or more tags may be useful to further aid with categorizing, organizing, or otherwise managing evidentiary data records. In particular, while a single evidentiary requirement may reference multiple evidentiary data records such that these data records are associated with a particular evidentiary domain, a given evidentiary data record may be differentiable and/or unique amongst other evidentiary data records within the same evidentiary domain. As such, labelling evidentiary data records with pertinent tags may aid end users in identifying evidentiary data records of interest. In some embodiments, a tag may include a file type, associated users, associated departments, a submitting user, a standardized or categorical evidentiary data record type (e.g., form 35b), an associated evidentiary domain, an associated evidentiary requirement identifier, an associated support container identifier, an associated project identifier, an associated change identifier, and/or the like.

In some embodiments, the data management circuitry 208 may determine one or more tags using a tagging model. The tagging model may be a rules-based or machine learning model that is configured to process the evidentiary data record and/or associated metadata to determine one or more tags for the evidentiary data record. In some embodiments, the tagging model may be a neural network (e.g., RNN or LSTM) or supervised machine learning model (e.g., support vector machines (SVMs), Naïve Bayes model, random forest and decision tree model) that is trained using evidentiary data records tagged with tags of interest. The tagging model may be trained using these tagged evidentiary data records and may further, be configured with rules or parameters indicative of possible tags for a given evidentiary data record. The tagging model may further use natural language processing (NLP) techniques to determine one or more tags for a given evidentiary data record.

Additionally, or alternatively, in some embodiments, the received evidentiary data record may include one or more tags as provided by the user. Thus, the data management circuitry 208 may determine the at least one tag from the received evidentiary data record. The data management circuitry 208 may also receive tags from the user via communications hardware 206 as user interactions with a user interface of a client device (e.g., any one of client devices 106A-106N). In some embodiments, the data management circuitry 208 may use communications hardware 206 to prompt the user to review the determined tags for the evidentiary data record. In an instance in which the user confirms a tag via his/her client device, the communications hardware 206 may receive this confirmation and provide this to data management circuitry 208. Data management circuitry 208 may then affirmatively determine the tag for the evidentiary data record. Alternatively, in an instance in which the communications hardware 206 receives a denial of one or more tags or does not receive a response within a threshold time frame, the data management circuitry 208 may discard the denied tags or all tags in an instance in which no confirmation is received from the user.

Optionally, as shown by operation 412, the apparatus 200 may include means, such as processor 202, memory 204, communications hardware 206, data management circuitry 208, or the like, for storing the evidentiary data record in a designated storage repository. As described above, in some embodiments, the data management circuitry 208 may store the received evidentiary data record in a designated storage repository. The designated storage repository may be a central storage repository accessible to apparatus 200 and/or designated users, such as storage repository 108. The designated storage repository may serve as a central location for storing evidentiary data records. The evidentiary data records stored by the designated storage repository may be used as the primary location or may serve as a back-up location as a failsafe for issues with the primary storage location, such as if the original storage location and/or stored evidentiary data record becomes inaccessible. In some embodiments, the evidentiary data record may directly be stored in the designated storage repository such that the original storage location is the designated storage repository. The evidentiary data record may be stored in its original file format and may keep its associated metadata.

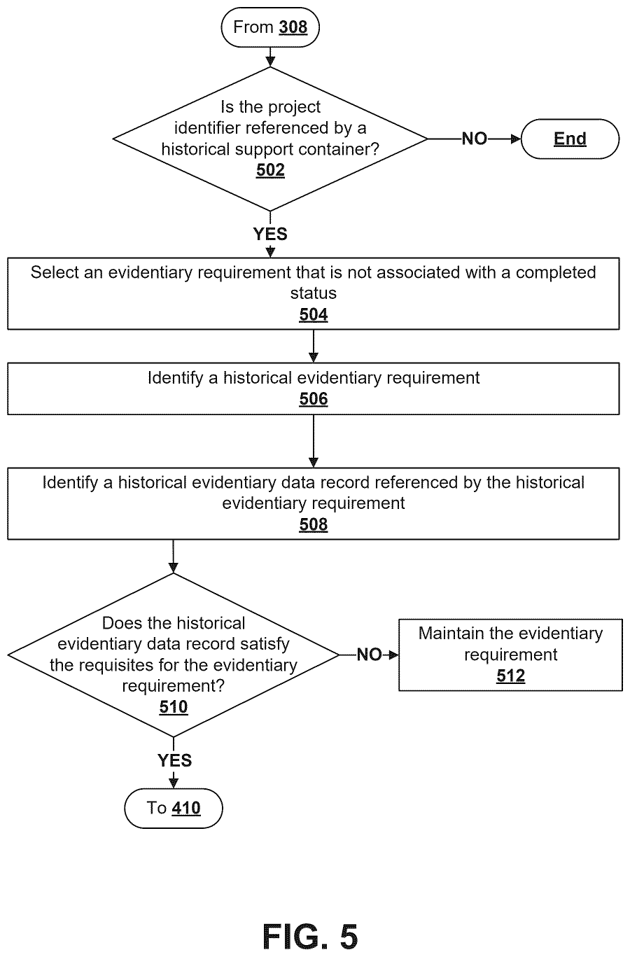

In some embodiments, in an instance in which at least one tag is determined for the evidentiary data record, the data management circuitry 208 may store the evidentiary data record in the designated data repository and may assign the at least one tag to the evidentiary data record. As such, the evidentiary data record may be stored in association with the at least one tag. These tags may aid in user interactions, queries, and/or other analytic purposes, such as the operations described in FIGS. 5-7.

As shown by operation 414, the apparatus 200 may include means, such as processor 202, memory 204, data management circuitry 208, or the like, for updating the identified evidentiary requirement to reference the evidentiary data record. Once the data management circuitry 208 has identified the evidentiary requirement associated with the evidentiary data record, and optionally determined it satisfies requisites of the evidentiary requirement, determined at least one tag for the evidentiary data record, and/or stored the evidentiary data record in a designated repository, the data management circuitry 208 may update the identified evidentiary requirement to reference the evidentiary data record. In some embodiments, the identified evidentiary requirement may be updated to reference the storage location of the evidentiary data record or otherwise link to the evidentiary data record. The storage location may be the storage location as provided by the user or may be the storage location within the designated storage repository, such as storage repository 108. In some embodiments, the evidentiary requirement may be updated to reference or link to each storage location.

The data management circuitry 208 may update the evidentiary requirement based on the type of database of the evidentiary management database and/or how the evidentiary requirement is formatted. For example, as described above in FIG. 3, if the evidentiary management database is a relational database, the data management circuitry 208 may generate the one or more evidentiary requirements as a record in a table and the evidentiary requirement may each be a row within the table. The evidentiary requirement may include one or more columns and one or more columns may include reference or link to evidentiary data record. In some embodiments, the columns designated as evidentiary data record links may be dynamic such that any number of columns may be contemplated and allow for any number of referenced or linked evidentiary data records. Thus, the data management circuitry 208 may append a column or may update an empty value of an existing column to reference the storage location of the evidentiary data record or may link to the evidentiary data record directly. As such, the identified evidentiary requirement may be updated to reference a pertinent and submitted evidentiary data record for a given evidentiary domain. This may allow the evidentiary requirement to aggregate and maintain an association of all relevant and associated evidentiary data records for a given change request, thus ensuring these evidentiary data records remain accessible.

Optionally, as shown by operation 416, the apparatus 200 may include means, such as processor 202, memory 204, communications hardware 206, data management circuitry 208, or the like, for updating a status for the evidentiary requirement. As described above, the evidentiary requirement may be associated with a status. The status of the evidentiary may be indicative of whether record requirements for the evidentiary requirement have been satisfied. For example, an evidentiary requirement status may be not started, in progress, complete, and/or the like. When an evidentiary requirement is first generated for a change request, the status for the evidentiary requirement may be set to a default value, such as not started. In an instance in which the received evidentiary data record satisfies the requisites for the evidentiary requirement (e.g., is compliant), the data management circuitry 208 may update the status of the evidentiary requirement.

In some embodiments, the status of the evidentiary requirement may be updated to in progress or complete. In some embodiments, the evidentiary requirement may be associated with one or more record requirements. These record requirements may describe conditions, circumstances, or the like under which the evidentiary requirement is considered to be complete. For example, the one or more record requirements for a given evidentiary requirement may describe a total number of evidentiary data records required, a minimum number of evidentiary data records required, required types of evidentiary data records, required titles of evidentiary data records, and/or the like. Upon satisfaction of these record requirements, the status of the evidentiary requirement may be updated to complete. Otherwise, the status of the evidentiary requirement may be updated to or maintained as in progress.

In some embodiments, the data management circuitry 208 may update the status of the evidentiary requirement based on the current evidentiary data records that are linked or referenced by the evidentiary requirement and the received evidentiary data record. In particular, the data management circuitry 208 may be configured to determine whether the record requirements are satisfied in view of the linked evidentiary data records and the received evidentiary data record. In an instance in which each of the record requirements for the evidentiary requirement are satisfied, the data management circuitry 208 may update the status of the evidentiary requirement may be updated to complete. Otherwise, the data management circuitry 208 may update or maintain the status as in progress.

In some embodiments, a status for the identified evidentiary requirement may be manually updated by a user. For example, in some embodiments, the communications hardware 206 may receive an indication of a status update for the evidentiary requirement from the user via a client device (e.g., any one of client devices 106A-106N). This manual status update may be received with the evidentiary data record or may be received in a separate communication. Responsive to the manual status update, the data management circuitry 208 may update the status of the evidentiary requirement.

Optionally, as shown by operation 418, the apparatus 200 may include means, such as processor 202, memory 204, communications hardware 206, data management circuitry 208, or the like, for providing a change request status update. In some embodiments, the data management circuitry 208 may generate a change request status update indicative of the status of the evidentiary requirement. In some embodiments, the change request status update may further indicate the status of the other evidentiary requirements associated with the same support container as the identified evidentiary requirement. As such, an end user may be apprised of the status of each of the evidentiary requirements for a given change request.

The data management circuitry 208 may use communications hardware 206 to provide the change request status update. In some embodiments, the communications hardware 206 may provide the change request status update to one or more client devices (e.g., any one of client devices 106A-106N). In particular, the communications hardware 206 may provide the change request status update to the client device from which the evidentiary data record was received. It will be appreciated that any alert, status update, summary, or other communication discussed herein may be provided to users in a variety of formats, including but not limited to instant messages such as texts and emails, push notifications, telephonic calls, secure portal messages, and physical mail.

In some embodiments, data management circuitry 208 may be configured with one or more client devices to provide the change request status update. For example, a given evidentiary requirement may be associated with a particular department and the data management circuitry 208 may be configured to provide the change request status update to one or more users within the particular department (e.g., managers, administrators, or the like) such that these users may be aware status changes. In some embodiments, the change request status update may be provided periodically or semi-periodically (e.g., daily, weekly, biweekly, or the like) such that users may remain apprised of the current status of one or more evidentiary requirements and may determine is needed to complete each evidentiary requirement.

Optionally, as shown by operation 420, the apparatus 200 may include means, such as processor 202, memory 204, change implementation circuitry 210, or the like, for determining whether each of the evidentiary requirements is associated with a completed status. In some embodiments, change implementation circuitry 210 may be configured to periodically, semi-periodically, or responsive to a received evidentiary data record, determine whether each evidentiary requirement for a change request is associated with a completed status. In some embodiments, in an instance in which each of the one or more evidentiary requirements for a given support container are associated with a complete status, the change implementation circuitry 210 may perform a change implementation routine such that certain operations for the requested change may automatically be performed. This may reduce the manual burden on users who would otherwise need to manually review the status of each evidentiary requirement and then manually perform or initiate these actions.

In particular, in some embodiments, a second level support container may also be associated with a status, such as not started, in progress, or complete. In some embodiments, the change implementation circuitry 210 may identify second level support containers that are not currently associated with a complete status (e.g., are associated with a not started or in progress status) and determine a status for each of the one or more evidentiary requirements referencing the second level support container. In particular, the change implementation circuitry 210 may identify the evidentiary requirements that include a reference (e.g., a foreign key) to the support container identifier of the second level support container. Alternatively, the change implementation circuitry 210 may identify a support container identifier referenced by the identified evidentiary requirement and may use this support container identifier to determine additional evidentiary requirements that reference the support container identifier. The change implementation circuitry 210 may then determine whether a current status for each of the one or more evidentiary requirements indicates a complete status.

In an instance in which a current status for one or more of the evidentiary requirements indicates a non-complete status (e.g., a not started or in progress status), the process may proceed back to operation 402. Here, one or more evidentiary requirements associated with the change request may be associated with a status indicative that they are not yet complete. Thus, the change implementation routine cannot yet be performed. Therefore, the process may return to operation 402, where the data management circuitry 208 may wait to receive additional evidentiary data records and repeat operations 402-420.

In an instance in which a current status for each of the one or more evidentiary requirements indicates a complete status, the process may proceed to operation 422. As shown by operation 422, the apparatus 200 may include means, such as processor 202, memory 204, communications hardware 206, change implementation circuitry 210, or the like, for performing a change implementation routine. In some embodiments, each change request type may be associated with a change implementation routine. The change implementation circuitry 210 may be configured with a change implementation routine for each change request type. A change implementation routine may include or describe a set of operations that may automatically be performed by the change implementation circuitry 210 in accordance with the requested change. The set of operations may include one or more applications, software instructions, logic, and/or the like that may be executed by change implementation circuitry 210 to perform one or more preconfigured operations. The change implementation routine may further define an order for the operations to be performed such that the change implementation circuitry 210 may perform the operations described by the instructions in the required ordered flow.

By way of particular example, the change implementation routine for a update change request may include a set of instructions that instruct the change implementation circuitry 210 to push a software update to devices with a corresponding program installed and provide a communication (e.g., email, text message, push notification, or the like) to the user group associated with the software product. As another example, the change implementation routine for a new product change request may include a set of instructions that instruct the change implementation circuitry 210 to push the product to a centralized software center such that it is available for individual download, provide a communication to a defined user group indicative of the availability of the product, provide preset product guidance documents to users, and/or the like. As another example, the change implementation routine may instruct the change implementation circuitry 210 to send an alert, via the communications hardware 206, to one or more users via their client devices (e.g., any one of client devices 106A-106N) indicative of that the change request has the required evidentiary data records necessary for implementation. As such, the recipient users may be informed that the change described by the change request is now ready for implementation and may avoid any delay in implementation.

In some embodiments, one or more instructions or operations of the change implementation routine may require the change implementation circuitry 210 to receive user input and/or user approval from one or more designated users, such as administrators, managers, developers, etc. The change implementation circuitry 210 may use communications hardware 206 to provide prompts to one or more designated users via an associated client device (e.g., any one of client devices 106A-106N) and may wait until approval is received from the user prior to performing any subsequent operations.

### Example Operations for Updating Evidentiary Requirements Using Historical Support Containers

Turning next to FIG. 5, example operations are shown for leveraging historical evidentiary data records associated with the first level project to update one or more evidentiary requirements. In some embodiments, a particular project (e.g., software, product, technology) may be associated with multiple changes (e.g., multiple versions, releases, or updates). As such, the project may be associated with multiple change requests. These change requests may each result in a separate second level support container, which may reference the project identifier of the project. This allows for maintenance of the relationship of changes made to a given project over time and provides for a centralized architecture with a traceable history of multiple change activities for a given project. Furthermore, in some embodiments, historical evidentiary data records that are associated with previous change requests may be considered pertinent and/or of use to a current change request, as received in operation 302. As such, these historical evidentiary data records may be referenced or linked to a current evidentiary requirement. This may eliminate the storage of duplicative evidentiary storage records within a designated storage repository and furthermore, may provide for a more computationally efficient and streamlined solution by automatically considering whether one or more requisites of an evidentiary requirement may be satisfied by current historical evidentiary data records that pertain to the same project.

As shown by operation 502, the apparatus 200 may include means, such as processor 202, memory 204, data management circuitry 208, or the like, for determining whether a project identifier is referenced by one or more historical support containers. Once the data taxonomy has been implemented as described in FIG. 3, optionally, the data management circuitry 208 may further be configured to automatically determine whether one or more historical evidentiary data records pertain to one or more evidentiary requirements. As described above, a project identifier may act as a foreign key within associated second level support containers. Thus, data management circuitry 208 may use the project identifier referenced by a given support container and determine whether one or more historical support containers reference the same project identifier.

In an instance in which no historical support containers reference the project identifier, the process may end. In this instance, the project identifier may correspond to a newly added first level project such that the current second level support container is the first support container for the project. As such, there may be no historical support containers for data management circuitry 208 to consider and the process may end.

In an instance in which one or more historical support containers reference the project identifier, the process may proceed to operation 504. As shown by operation 504, the apparatus 200 may include means, such as processor 202, memory 204, data management circuitry 208, or the like, for selecting an evidentiary requirement that is not associated with a completed status. In an instance the project identifier is referenced by one or more historical support containers, the data management circuitry 208 may identify a current evidentiary requirement that is associated with a non-complete status (e.g., a not started or in progress status). Thus, the evidentiary requirement may still require that evidentiary data records to be linked or referenced in order to satisfy the one or more associated record requirements. As such, the data management circuitry 208 may select an evidentiary requirement as the evidentiary requirement of interest. It will be appreciated that operations 504-512 may be performed for each evidentiary requirement associated with a non-completed status at least once.

As shown by operation 506, the apparatus 200 may include means, such as processor 202, memory 204, data management circuitry 208, or the like, for identifying a historical evidentiary requirement. In particular, the data management circuitry 208 may identify possible historical evidentiary requirements that reference the historical support container identifier of the historical support container. The data management circuitry 208 may then identify a historical evidentiary requirement that is associated with an evidentiary domain that corresponds to the evidentiary domain of the selected evidentiary requirement. In particular, the data management circuitry 208 may identify a historical evidentiary requirement that is associated with the same evidentiary domain as the selected evidentiary requirement.

As shown by operation 508, the apparatus 200 may include means, such as processor 202, memory 204, data management circuitry 208, or the like, for identifying a historical evidentiary data record referenced by the historical evidentiary requirement. The identified historical evidentiary data record may reference or link to one or more historical evidentiary data records. The data management circuitry 208 may identify a historical evidentiary data record and proceed to operation 508 to determine whether the particular historical evidentiary data record can be used by the selected evidentiary requirement. It will be appreciated that operations 506-512 may be repeated for each historical evidentiary data record referenced by the identified historical evidentiary requirement.

As shown by operation 510, the apparatus 200 may include means, such as processor 202, memory 204, data management circuitry 208, or the like, for determining whether the historical evidentiary data record satisfies the one or more requisites for the selected evidentiary requirement. In some embodiments, the data management circuitry 208 may determine whether the historical evidentiary data record satisfies the one or more requisites for the selected evidentiary requirement in a manner substantially similar to operation 406. In some embodiments, the one or more requisites for a given evidentiary requirement may also define acceptable parameters for considering a historical evidentiary data record. In particular, in some embodiments, the one or more requisites for a given evidentiary requirement may define acceptable data ranges or time frames where a historical evidentiary data record may be considered valid. This may allow the data management circuitry 208 to exclude historical evidentiary data records that are considered outdated or non-useful for the current change request.

In an instance in which the historical evidentiary data record fails to satisfy a requisite for the selected evidentiary requirement, the process may proceed to operation 512. As shown by operation 512, the apparatus 200 may include means, such as processor 202, memory 204, data management circuitry 208, or the like, for maintaining the evidentiary requirement. If a historical data record fails to satisfy a requisite of the selected evidentiary requirement, the data management circuitry 208 may maintain the evidentiary requirement. That is, the data management circuitry 208 may not reference or link to the particular historical evidentiary data record.

In an instance in which the historical evidentiary data satisfies each of the one or more requisites for the selected evidentiary requirement, the process may proceed to operation 410. In this instance, the historical evidentiary data record may be referenced or linked to the selected evidentiary requirement and the processor 202, memory 204, communications hardware 206, data management circuitry 208, and/or change implementation circuitry 210 may treat the historical evidentiary data record as received evidentiary data record when performing the operations described in operation 410-422 of FIG. 4.

### Example Operations for Providing Automatic Violation Alerts

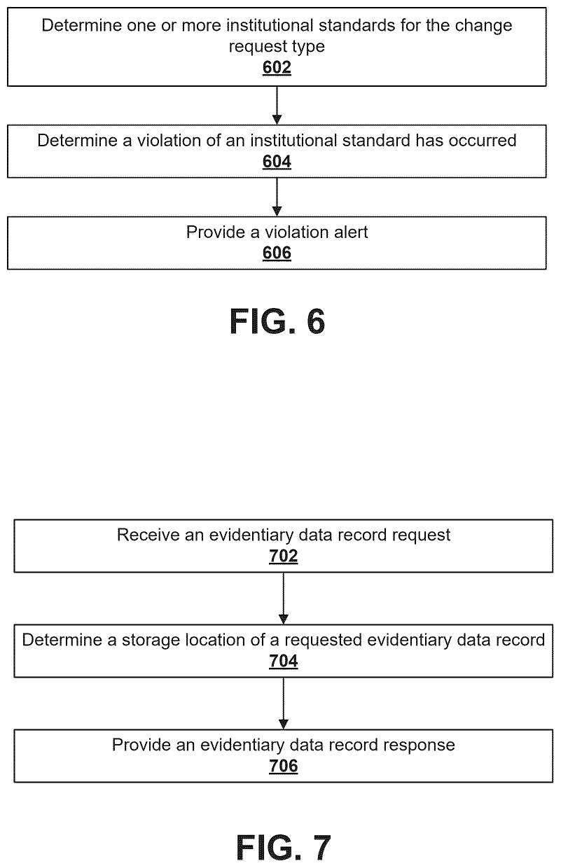

Turning next to FIG. 6, example operations are shown for automatically providing a violation alert responsive to detection of a violation of an institutional standard. In some embodiments, the apparatus 200 may be configured with one or more institutional standards for a given change request type. These institutional standards may define expectations and/or temporal boundaries associated with a particular change request. In some embodiments, the apparatus 200 may automatically determine one or more of these institutional standards, such as by using an inference machine learning model. Additionally, use of such an institutional machine learning model may allow for the model to be retrained and/or updated, such that it may automatically update institutional standards to reflect dynamic institutional standards.

As shown by operation 602, the apparatus 200 may include means, such as processor 202, memory 204, data management circuitry 208, or the like, for determining one or more institutional standards for the change request type. In some embodiments, a change request type may be associated with one or more institutional standards that define temporal expectations and/or other guidelines for the change request type. For example, institutional standards may define an expected time frame during which an evidentiary data record is expected to be received within, an expected time frame during which an evidentiary requirement is expected to be completed within (e.g., as indicated by its associated status), and/or the like. These one or more institutional standards for a given change request type may be associated with the change request type and may be stored and/or maintained in an associated memory, such as memory 204.

In some embodiments, one or more institutional standards may be set or preconfigured by an authorized user (e.g., an administrator, supervisor, developer, or the like). Authorized users may update and/or change these institutional standards via client device (e.g., any one of client devices 106A-106N).

Additionally, or alternatively, in some embodiments, the data management circuitry 208 may use an inference machine learning model to determine one or more institutional standards for the change request type. In some embodiments, the inference machine learning model may be a neural network (e.g., RNN, LSTMs, or the like) that may be trained to infer boundaries for one or more institutional standards. In particular, the inference machine learning model may be trained using an unsupervised training approach. For example, the inference machine learning model may be provided data indicative of when various evidentiary data records were received, what evidentiary requirement the received evidentiary data records were associated with, a status of each evidentiary requirement over time, and/or the like. The data may be associated with temporal data for a given change request type. As such, the inference machine learning model may be trained to infer temporal information and/or expectations for a given change request type. In some embodiments, the inference machine learning model may employ various techniques, such as clustering algorithms (e.g., K-means, LDA, DBSCAN, or the like) to determine the one or more institutional standards.

In particular, in some embodiments, the one or more institutional standards determined by the inference machine learning model may be an expected lower temporal threshold for a given evidentiary data record. This value may be indicative of an earliest expected time from the receipt of the change request that a particular evidentiary data record is expected to be received. In some embodiments, the one or more institutional standards determined by the inference machine learning model may be an expected upper temporal threshold for a given evidentiary data record. This value may be indicative of a latest expected time from the receipt of the change request that a particular evidentiary data record is expected to be received. A particular evidentiary data record may be categorized and/or identified based on its associated title, file type, and/or the like.

In some embodiments, the one or more institutional standards determined by the inference machine learning model may be an expected lower temporal threshold for a given evidentiary requirement. This value may be indicative of an earliest expected time from the receipt of the change request that an evidentiary requirement is expected to be associated with a completed status. In some embodiments, the one or more institutional standards determined by the inference machine learning model may be an expected upper temporal threshold for a given evidentiary requirement. This value may be indicative of a latest expected time from the receipt of the change request that an evidentiary requirement is expected to be associated with a completed status. A particular evidentiary requirement may be categorized and/or identified based on its associated evidentiary domain.

As shown by operation 604, the apparatus 200 may include means, such as processor 202, memory 204, data management circuitry 208, or the like, for determining that a violation of an institutional standard has occurred. For example, data management circuitry 208 may determine whether a particular evidentiary data record has been received in advance of an expected lower temporal threshold or has not been received after an expected upper temporal threshold. As another example, data management circuitry 208 may determine whether a particular evidentiary requirement is associated with a complete status in advance of an expected lower temporal threshold or is not associated with a complete status after an expected upper temporal threshold. This may be indicative that there is a potential institutional violation and/or concern for the given evidentiary data record and/or evidentiary requirement.

Finally, as shown by operation 606, the apparatus 200 may include means, such as processor 202, memory 204, communications hardware 206, data management circuitry 208, or the like, for providing a violation alert. A violation alert may be indicative that a violation has been determined for a change request and further, may be indicative of the particular institutional standard that was violated, as determined in operation 604. As such, the violation alert may provide notice to one or more end users, who may then review associated evidentiary data records and/or evidentiary requirements and take appropriate action to keep the project on track.

The data management circuitry 208 may generate the violation alert and use the communications hardware 206 to provide the violation alert to one or more designated users. In some embodiments, the communications hardware 206 may provide the violation alert to one or more client devices (e.g., any one of client devices 106A-106N). In some embodiments, the communications hardware 206 may provide the violation alert to one or more designated users (e.g., administrators, managers, developers, etc.), The violation alert may be provided to users in any suitable formats, including but not limited to instant messages such as texts and emails, push notifications, telephonic calls, secure portal messages, and physical mail.

### Example Operations for Providing Requested Evidentiary Data Records

Turning next to FIG. 7, example operations are shown for handling an evidentiary data record request. In some embodiments, a user may wish to review or otherwise access an evidentiary data record associated with a particular project, change request, evidentiary domain, etc. The user may provide an evidentiary data record request indicative of one or more requested evidentiary data records to apparatus 200 and in turn, apparatus 200 may provide an evidentiary data record response that includes the requested evidentiary data record or provides a link to the evidentiary data record. As such, stored evidentiary data records may remain accessible to users, such as for auditing and/or compliance purposes.

As shown by operation 702, the apparatus 200 may include means, such as processor 202, memory 204, communications hardware 206, data management circuitry 208, or the like, for receiving an evidentiary data record request. The evidentiary data record request may be indicative of a request for an evidentiary data record associated with a particular project, change request, evidentiary domain, etc. For example, the evidentiary data record request may include a project identifier, a change identifier, a support container identifier, an evidentiary requirement identifier, an evidentiary domain selection, document name, and/or the like. In some embodiments, the evidentiary data record may further include one or more user identifiers and/or user credentials that uniquely identify the requested user.

In some embodiments, the communications hardware 206 may receive the evidentiary data record request from a client device (e.g., any one of client devices 106A-106N). In some embodiments, receiving the evidentiary data record request may be accomplished via a wired or wireless connection, and may be performed by the communications hardware 206. For example, a wireless interface card may receive a stream of data packets containing an encrypted change request divided among payloads of several packets. Payloads of these packets may be decrypted and assembled (not necessarily in that order) to reconstruct the change request. The change request may then be passed to the data management circuitry 208 for processing. In another example, a network interface may receive a stream of data via a wired connection containing a change request in an unencrypted form. This data may be parsed, and/or the data may be passed through the communications hardware 206 to the data management circuitry 208 for processing.

As shown by operation 704, the apparatus 200 may include means, such as processor 202, memory 204, data management circuitry 208, or the like, for determining a storage location of a requested evidentiary data record. Responsive to the receipt of the evidentiary data record request, the data management circuitry 208 may be configured to determine one or more evidentiary data records indicated in the evidentiary data record request. This may depend on the information and/or selection provided by the evidentiary data record request. For example, if a support container identifier is provided in the evidentiary data record request, the data management circuitry 208 may determine all evidentiary data records referenced or linked to an evidentiary requirement that references the support container identifier. As another example, if an evidentiary domain and document name is provided in the evidentiary data record request, the data management circuitry 208 may determine only a single evidentiary data record associated with the provided document name that is linked or referenced in an evidentiary requirement associated with the provided evidentiary domain. The data management circuitry 208 may use the references or links to the determined evidentiary data records within the associated evidentiary requirements to determine a storage location for the evidentiary data records. In some embodiments, the storage location is within the designated repository (e.g., storage repository 108).

In some embodiments, the data management circuitry 208 may determine whether the user and/or client device (e.g., any one of client devices 106A-106N) that provided the evidentiary data record request is authorized to access or view the determined evidentiary data records. In some embodiments, evidentiary data records may be associated with security restrictions and/or permissions which permit or deny certain users from viewing and/or accessing the evidentiary data record. Thus, the data management circuitry 208 may determine whether the requesting user is authorized to view and/or access an evidentiary data record. For example, the data management circuitry 208 may determine whether security restrictions and/or permission of the evidentiary data record permit a user with the provided user identifier and/or user credentials to access and/or view the evidentiary data record. In an instance the user is permitted to access the evidentiary data record, it may be included in the evidentiary data record response. Otherwise, the evidentiary data record may be excluded from the evidentiary data record response.

Finally, as shown by operation 706, the apparatus 200 may include means, such as processor 202, memory 204, communications hardware 206, data management circuitry 208, or the like, for providing an evidentiary data record response. Once the data management circuitry 208 determines a storage location for each evidentiary data record, it may generate the evidentiary data record response. In some embodiments, the evidentiary data record response may include a link to each evidentiary data record. In some embodiments, the evidentiary data record response may include a local copy of the evidentiary data record itself.

The data management circuitry 208 may generate the evidentiary data record response and use the communications hardware 206 to provide the evidentiary data record response to one or more users. In some embodiments, the communications hardware 206 may provide the evidentiary data record response to one or more client devices (e.g., any one of client devices 106A-106N), such as the client device from which the evidentiary data record request was received. The evidentiary data record response may be provided to users in any suitable formats, including but not limited to instant messages such as texts and emails, push notifications, telephonic calls, secure portal messages, and physical mail.

### Example Operations for Handling Additional Change Requests

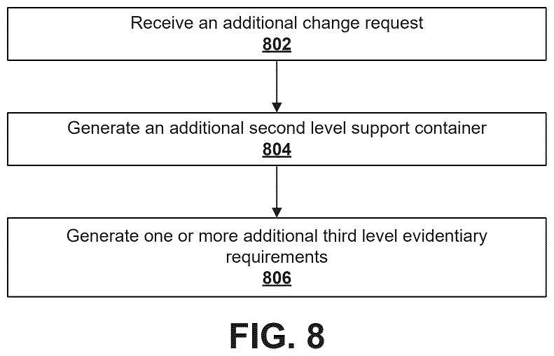

Turning next to FIG. 8, example operations are shown for processing an additional change request for a given project. In some embodiments, a particular project (e.g., software, product, technology) may be associated with multiple changes (e.g., multiple versions, releases, or updates) and may therefore be associated with multiple change requests. Once a project identifier exists for a given project, additional change requests may result in an additional second level support container and additional third level evidentiary requirements. Here, the additional support container may reference the project identifier, thereby maintaining the relationship of changes made to a given project over time and provides for a centralized architecture with a traceable history of multiple change activities for a given project.

As shown by operation 802, the apparatus 200 may include means, such as processor 202, memory 204, communications hardware 206, data management circuitry 208, or the like, for receiving an additional change request. An additional change request may include a project identifier and a change request type. The data management circuitry 208 may determine that the project identifier included in the additional change request is associated with a first level project and thus, may determine it need not generate a first level project. In some embodiments, operation 802 may be performed in a substantially similar manner as operation 302.

As shown by operation 804, the apparatus 200 may include means, such as processor 202, memory 204, data management circuitry 208, or the like, for generating an additional second level support container. In some embodiments, operation 804 may be performed in a substantially similar manner as operation 306. Here, the additional support container may reference the project identifier indicated by the additional change request. As such, the first level project may be referenced by multiple second level support containers. Additionally, the record for the second level support container may include a unique support container identifier, which may uniquely identify it from other support containers and/or may include a change identifier. The change identifier included in the additional support container may uniquely identify the additional change request.

Finally, as shown by operation 806, the apparatus 200 may include means, such as processor 202, memory 204, data management circuitry 208, or the like, for generating one or more additional third level evidentiary requirements. In some embodiments, operation 806 may be performed in a substantially similar manner as operation 308. Here, the additional evidentiary requirements may reference the additional support container identifier.

FIGS. 3-8 illustrate operations performed by apparatuses, methods, and computer program products according to various example embodiments. It will be understood that each flowchart block, and each combination of flowchart blocks, may be implemented by various means, embodied as hardware, firmware, circuitry, and/or other devices associated with execution of software including one or more software instructions. For example, one or more of the operations described above may be implemented by execution of software instructions. As will be appreciated, any such software instructions may be loaded onto a computing device or other programmable apparatus (e.g., hardware) to produce a machine, such that the resulting computing device or other programmable apparatus implements the functions specified in the flowchart blocks. These software instructions may also be stored in a non-transitory computer-readable memory that may direct a computing device or other programmable apparatus to function in a particular manner, such that the software instructions stored in the computer-readable memory comprise an article of manufacture, the execution of which implements the functions specified in the flowchart blocks.

The flowchart blocks support combinations of means for performing the specified functions and combinations of operations for performing the specified functions. It will be understood that individual flowchart blocks, and/or combinations of flowchart blocks, can be implemented by special purpose hardware-based computing devices which perform the specified functions, or combinations of special purpose hardware and software instructions.

### Example Data Taxonomy Structure

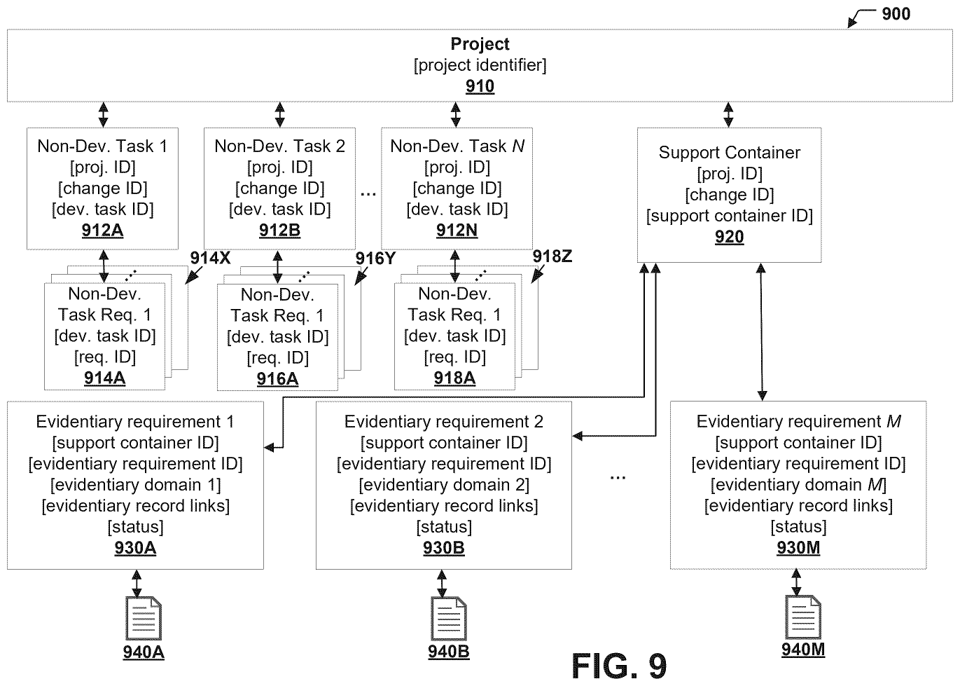

FIG. 9 illustrates an example data taxonomy structure 900 depicting example taxonomic relationships (e.g., as described above in connection with FIGS. 3-8) pertaining to various data elements described in FIGS. 3-8 as potentially implemented by the devices, systems, and apparatuses of FIGS. 1 and 2.

As shown by data taxonomy structure 900, a project 910 may define a first or top level of the data taxonomy. The project 910 may be associated with a project identifier, which may uniquely define the project. A second level may define a support container 920 along with one or more non-development tasks 912A, 912B, and 912N. The support container 920 and each non-development task 912A-912N may reference the project identifier such that these second level items have a hierarchical relationship to project 910. The support container 920 and each non-development task 912A-912N may further be associated with a change identifier, which may identify a change request with which the support container and/or non-development task is associated. Additionally, the support container 920 may be associated with a support container identifier, which may uniquely identifier the support container. Each non-development task 912A-912N may also be associated with a non-development task identifier, which may uniquely identify each non-development task.

A third level may define one or more evidentiary requirements 930A, 930B, and 930M. The one or more evidentiary requirements 930A, 930B, and 930M may reference the support container identifier such that these third level items have a hierarchical relationship to support container 920, and furthermore project 910. The one or more evidentiary requirements 930A, 930B, and 930M may also be associated with a unique evidentiary domain and an evidentiary requirement identifier, which may uniquely identify each evidentiary requirement. Furthermore, each evidentiary requirement 930A, 930B, and 930M may be associated with a status and further, may reference and/or link to one or more evidentiary data records 940A, 940B, and 940M, respectively. Although only one evidentiary data record is shown for each evidentiary requirement, it will be appreciated that an evidentiary requirement may reference and/or link to multiple evidentiary data records.

The third level may also define one or more non-development task requirements 914A, 914X, 916A, 916Y, 918A, and 918Z. Each of the one or more non-development task requirements may reference a corresponding non-development task such that these third level items have a hierarchical relationship to a non-development task. In particular, non-development tasks requirements 914A through 914X may reference the non-development task identifier for non-development task 912A, non-development tasks requirements 916A through 916Y may reference the non-development task identifier for non-development task 912B, and non-development tasks requirements 918A through 918Z may reference the non-development task identifier for non-development task 912N. The one or more non-development task requirements 914A-914X, 916A-916Y, and 918A-918Z may also be associated with a non-development task requirement identifier, which may uniquely identify each non-development task requirement.

### Example User Interface

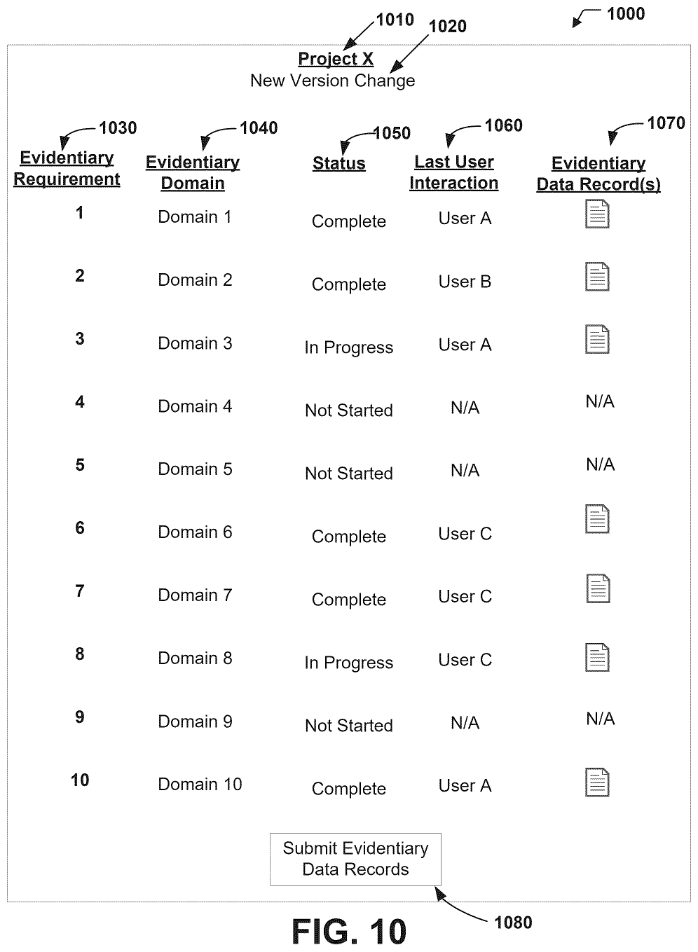

Turning now to FIG. 10, a graphical user interface (GUI) 1000 is provided that illustrates an example user interface for the devices, systems, methods, and apparatuses described herein. As noted previously, a user may interact with the evidentiary management system 102 by directly engaging with communications hardware 206 of an apparatus 200 comprising the evidentiary management system 102. In such an embodiment, the GUI shown in FIG. 10 may be displayed to a user by the apparatus 200. Alternatively, a user may interact with the evidentiary management system 102 using a separate client device (e.g., any of the client devices 106A-106N, as shown in FIG. 1), which may communicate with the evidentiary management system 102 via communications network 104. In such an embodiment, the GUI shown in FIG. 10 may be displayed to the user by the client device.

The GUI 1000 may be accessible to authorized users via apparatus 200 or a separate client device. In some embodiments, GUI 1000 may be part of an internal platform that users may use for agile workflow management of projects and associated change requests. For example, users may use the internal platform to view a status of an evidentiary requirement within an evidentiary domain, determine who the previous user was to interact with the evidentiary requirement, access evidentiary data records, submit evidentiary data records, create and/or manage change requests, and/or the like.

As shown in GUI 1000, the interface may display various components associated with a project 1010 for a given change request 1020 of a change request type. Here, the project 1010 may be associated with a change request type for a new version of the product. The GUI 1000 may display the one or more evidentiary requirements 1030 each associated with an evidentiary domain 1040 for the change request. Additionally, the GUI 1000 may display a status 1050 for each evidentiary requirement 1030 and in some embodiments, may indicate the last user who interacted with the evidentiary requirement 1060 (e.g., a user who most recently provided an evidentiary data record). Additionally, the GUI 1000 may provide a link or access to the one or more evidentiary data records 1070 for a given evidentiary requirement. In some embodiments, the GUI 1000 may further include an interaction element 1080 that a user may interact with it to submit an evidentiary data record.

The GUI 1000 may allow a user to interact with an icon for a given evidentiary data record (e.g., select, click, tap, or the like) to view one or more associated evidentiary data records, provide a preview of associated data records, provide a link to associated evidentiary data records, and/or the like. In some embodiments, the GUI may allow users to filter evidentiary data records for a given evidentiary requirement using one or more tags. In some example embodiments, the GUI 1000 may further allow a user to select an evidentiary requirement and view associated evidentiary data record history (e.g., submitted evidentiary data record information and/or submitting user information) and further, may further display record requirements for a given evidentiary requirement. Thus, users may be made aware of what evidentiary data records and/or outstanding requirements are needed in order to complete an evidentiary requirement.

### CONCLUSION

As described above, example embodiments provide methods and apparatuses that enable improved approval and implementation of changes while providing up-to date progress data to involved parties. Example embodiments thus provide tools that overcome the problems faced by conventional evidentiary data record review. For example, by avoiding the need to manually perform evaluations of evidentiary data records, example embodiments thus save time and resources, while also reducing or eliminating the possibility of human error that has been unavoidable in the past. Moreover, embodiments described herein advantageously detect behavior exploitative of system structures and alert administrators to such behavior. For example, by leveraging rules-based and machine learning techniques, evidentiary data records that do not comply with various institutional policies and/or regulations may be identified, and users may be proactively alerted to this non-compliance, thus conserving future time and resources.

As these examples all illustrate, example embodiments contemplated herein provide technical solutions that solve real-world problems faced during change request evaluation. And while managing change at institutional scales has been an issue for decades, the recently exploding amount of data made available by recently emerging technology today has made this problem significantly more acute, as the demand for evidentiary data record verification and change management oversight has grown significantly even while the complexity of change management has itself increased. At the same time, the recently arising ubiquity of machine learning techniques has unlocked new avenues to solving this problem that historically were not available, and example embodiments described herein thus represent a technical solution to these real-world problems.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method for managing evidentiary data records, the method comprising:
receiving, by communications hardware, a change request comprising (a) a project identifier and (b) a change request type;
in response to receiving the change request, generating, by data management circuitry, a support container, wherein (a) the support container references the project identifier and (b) the support container is associated with a support container identifier;
generating, by the data management circuitry and based on the change request type, one or more evidentiary requirements, wherein (a) the one or more evidentiary requirements reference the support container identifier and (b) the one or more evidentiary requirements are each associated with an evidentiary domain;
receiving, by the communications hardware, an evidentiary data record associated with the change request;
identifying, by the data management circuitry, an evidentiary requirement of the one or more evidentiary requirements associated with the evidentiary data record; and
updating, by the data management circuitry, the identified evidentiary requirement to reference the evidentiary data record.

2. The method of claim 1, further comprising storing, by the data management circuitry, the evidentiary data record in a designated storage repository.

3. The method of claim 1, further comprising:
determining, by the data management circuitry, whether the evidentiary data record satisfies each requisite associated with the identified evidentiary requirement; and
in an instance in which the evidentiary data record satisfies each requisite for the identified evidentiary requirement, updating, by the data management circuitry, a status for the identified evidentiary requirement.

4. The method of claim 3, further comprising providing, by the communications hardware, a change request status update, wherein the change request status update is indicative of the updated status for the identified evidentiary requirement.

5. The method of claim 3, further comprising:
determining, by change implementation circuitry, whether each of the one or more evidentiary requirements is associated with a completed status; and
in an instance in which each of the one or more evidentiary requirements is associated with a completed status, performing, by the change implementation circuitry, a change implementation routine associated with the change request type.

6. The method of claim 1, the method further comprising:
determining, by the data management circuitry, that the evidentiary data record fails to satisfy a requisite for the identified evidentiary requirement; and
providing, by the communications hardware, an evidentiary requirement alert, wherein the evidentiary requirement alert is indicative that the received evidentiary data record fails to satisfy the requisite.

7. The method of claim 1, the method further comprising:
determining, by the data management circuitry, whether the project identifier is referenced by a historical support container;
in an instance in which the project identifier is referenced by the historical support container, selecting, by the data management circuitry, an evidentiary requirement not associated with a completed status;
identifying, by the data management circuitry, a historical evidentiary requirement that references the historical support container and is associated with an evidentiary domain that corresponds to the evidentiary domain of the selected evidentiary requirement;
identifying, by the data management circuitry, a historical evidentiary data record referenced by the historical evidentiary requirement;
determining, by the data management circuitry, whether the historical evidentiary data record satisfies each requisite for identified evidentiary requirement; and
in an instance in which the historical evidentiary data record satisfies each requisite for the identified evidentiary requirement, updating, by the data management circuitry, the selected evidentiary requirement to reference the historical evidentiary data record.

8. The method of claim 1, further comprising:
receiving, by the communications hardware, an update request indicative of a request for an evidentiary data record;
determining, by the data management circuitry, a storage location of the requested evidentiary data record; and
providing, by the communications hardware, an update response, wherein the update response comprises at least one of (a) a link to the requested evidentiary data record or (b) the requested evidentiary data record.

9. The method of claim 1, further comprising:
receiving, by the communications hardware, an additional change request comprising (a) the project identifier and (b) a change request type for the additional change request;
in response to receiving the additional change request, generating, by the data management circuitry, an additional support container, wherein (a) the additional support container references the project identifier and (b) the additional support container is associated with an additional support container identifier; and
generating, by the data management circuitry and based on the change request type, one or more additional evidentiary requirements, wherein (a) the one or more additional evidentiary requirements reference the additional support container identifier and (b) the one or more additional evidentiary requirements are each associated with an evidentiary domain.

10. The method of claim 1, the method further comprising:
determining, by the data management circuitry, one or more institutional standards for the change request type;
determining, by the data management circuitry, a violation of the one or more institutional standards has occurred; and
providing, by the communications hardware, a violation alert, wherein the violation alert is indicative of the violation and the one or more institutional standards associated with the violation.

11. The method of claim 1, the method further comprising:
determining, by the data management circuitry, at least one tag associated with the evidentiary data record; and
assigning, by the data management circuitry, the at least one tag to the evidentiary data record.

12. An apparatus for managing evidentiary data records, the apparatus comprising:
communications hardware configured to:
receive a change request comprising (a) a project identifier and (b) a change request type;
data management circuitry configured to:
in response to receiving the change request, generate a support container, wherein (a) the support container references the project identifier and (b) the support container is associated with a support container identifier, and
generate, based on the change request type, one or more evidentiary requirements, wherein (a) the one or more evidentiary requirements reference the support container identifier and (b) the one or more evidentiary requirements are each associated with an evidentiary domain;
wherein the communications hardware is further configured to receive an evidentiary data record associated with the change request;
wherein the data management circuitry is further configured to:
identify an evidentiary requirement of the one or more evidentiary requirements associated with the evidentiary data record, and
update the identified evidentiary requirement to reference the evidentiary data record.

13. The apparatus of claim 12, wherein the data management circuitry is further configured to store the evidentiary data record in a designated storage repository.

14. The apparatus of claim 12, wherein the data management circuitry is further configured to:
determine whether the evidentiary data record satisfies each requisite associated with the identified evidentiary requirement; and
in an instance in which the evidentiary data record satisfies each requisite for the identified evidentiary requirement, update a status for the identified evidentiary requirement.

15. The apparatus of claim 14, wherein the communications hardware is further configured to provide a change request status update, wherein the change request status update is indicative of the updated status for the identified evidentiary requirement.

16. The apparatus of claim 14, further comprising change implementation circuitry configured to:
determine whether each of the one or more evidentiary requirements is associated with a completed status; and
in an instance in which each of the one or more evidentiary requirements is associated with a completed status, perform a change implementation routine associated with the change request type.

17. The apparatus of claim 12, wherein the data management circuitry is further configured to determine that the evidentiary data record fails to satisfy a requisite for the identified evidentiary requirement; and
wherein the communications hardware is further configured to provide an evidentiary requirement alert, wherein the evidentiary requirement alert is indicative that the received evidentiary data record fails to satisfy the requisite.

18. The apparatus of claim 12, wherein the data management circuitry is further configured to:
determine whether the project identifier is referenced by a historical support container;
in an instance in which the project identifier is referenced by the historical support container, select an evidentiary requirement not associated with a completed status;
identify a historical evidentiary requirement that references the historical support container and is associated with an evidentiary domain that corresponds to the evidentiary domain of the selected evidentiary requirement;
identify a historical evidentiary data record referenced by the historical evidentiary requirement;
determine whether the historical evidentiary data record satisfies each requisite for identified evidentiary requirement; and
in an instance in which the historical evidentiary data record satisfies each requisite for the identified evidentiary requirement, update the selected evidentiary requirement to reference the historical evidentiary data record.

19. The apparatus of claim 12, wherein the communications hardware is further configured to receive an update request indicative of a request for an evidentiary data record;
wherein the data management circuitry is further configured to determine a storage location of the requested evidentiary data record; and
wherein the communications hardware is further configured to provide an update response, wherein the update response comprises at least one of (a) a link to the requested evidentiary data record or (b) the requested evidentiary data record.

20. A computer program product for managing evidentiary data records, the computer program product comprising at least one non-transitory computer-readable storage medium storing software instructions that, when executed, cause an apparatus to:
receive a change request comprising (a) a project identifier and (b) a change request type;
in response to receiving the change request, generate a support container, wherein (a) the support container references the project identifier and (b) the support container is associated with a support container identifier;
generate, based on the change request type, one or more evidentiary requirements, wherein (a) the one or more evidentiary requirements reference the support container identifier and (b) the one or more evidentiary requirements are each associated with an evidentiary domain;
receive an evidentiary data record associated with the change request;
identify an evidentiary requirement of the one or more evidentiary requirements associated with the evidentiary data record; and
update the identified evidentiary requirement to reference the evidentiary data record.
